(19) United States
(12) Patent Application Publication
(10) Pub. No.: US 2016/0378557 A1
(43) Pub. Date: Dec. 29, 2016

(54) TASK ALLOCATION DETERMINATION APPARATUS, CONTROL METHOD, AND PROGRAM

(71) Applicant: NEC CORPORATION, Tokyo (JP)

(72) Inventor: Masato ASAHARA, Tokyo (JP)

(73) Assignee: NEC Corporation, Tokyo (JP)

(21) Appl. No.: 14/902,428

(22) PCT Filed: May 16, 2014
(86) PCT No.: PCT/JP2014/063021

§ 371 Date: Dec. 31, 2015

(30) Foreign Application Priority Data
Jul. 3, 2013 (JP) 2013-139860

(51) Int. Cl. G06F 9/50; H04L 12/26; H04L 29/08

(52) U.S. Cl. CPC G06F 9/5027; H04L 67/1002; H04L 43/10

(57) ABSTRACT

A distributed system (3000) includes processing servers (3200). A task is allocated to a processing server (3200). A speed information acquisition unit (2020) acquires speed information, which is information relating to a processing speed of the task in execution on the processing server (3200). An abnormality determination unit (2040) determines whether or not a processing speed of a task to be determined is abnormal using the speed information. When the processing speed of the task to be determined is determined to be abnormal by the abnormality determination unit (2040), an allocation exclusion unit (2060) temporarily excludes the processing server (3200) to which the task is allocated, from allocation targets of a new task.

### TECHNICAL FIELD

The present invention relates to a task allocation technique in a distributed system.

### BACKGROUND ART

A distributed system has been developed, in which a plurality of computers (hereinafter, processing servers) execute a distributed plurality of tasks generated by dividing a job. When the processing servers become a state where they are able to execute tasks, a new task is allocated thereto. In a distributed system having such a configuration, new tasks are allocated in the order from processing servers in which tasks are completed, and thus a higher-speed processing server tends to be allocated more tasks. As a result, the execution efficiency of a job increases.

There are Non-Patent Document 1 and Patent Documents 1 to 5 that disclose techniques for allocating tasks to processing servers or techniques related to them. Non-Patent Document 1 discloses a technique for predicting a time required for processing a task which is executed on a processing server, and shortening a time required for processing the task during execution when the time is sufficiently longer than a time required for processing tasks which have been executed so far. Specifically, a time required for processing a task during execution is shortened by a method of 1) re-starting the task during the execution on the same server, 2) duplicating the task during the execution and executing the duplicated task on the same server, or 3) duplicating the task during the execution and allocating the duplicated task to a plurality of other processing servers.

Patent Documents 1 and 2 disclose a technique in which an allocation schedule of tasks is statically determined on the basis of the load index of tasks and the performance index of a processing server which are measured in advance. Patent Document 3 discloses a technique in which, when the completion time of a job estimated on the basis of the progress situation of a job does not satisfy the required completion time of a job, the job is divided into a plurality of tasks, and the divided tasks are allocated to a plurality of processing servers, thereby processing the tasks in parallel. Patent Document 4 discloses a technique in which a task is allocated to a high-performance processing server on the basis of a static performance index value which is calculated on the basis of the configuration of a processing server. Patent Document 5 discloses a technique in which a contract CPU usage rate is set for each contract user, and the start of a new process received from the contract user is delayed for a predetermined time when the CPU usage rate of a process received from the contract user exceeds the contract CPU usage rate.

### RELATED DOCUMENTS

### Patent Documents

[Patent Document 1] Japanese Unexamined Patent Application Publication No. 2008-243216
[Patent Document 2] Japanese Unexamined Patent Application Publication No. 2010-277604
[Patent Document 3] Japanese Unexamined Patent Application Publication No. 2008-123205
[Patent Document 4] Japanese Unexamined Patent Application Publication No. 2007-317038
[Patent Document 5] Japanese Unexamined Patent Application Publication No. 2012-156800
[Non-Patent Document 1] Ganesh Ananthanarayanan, and six others, “Reining in the Outliers in Map-Reduce Clusters using Mantri”, Proceedings of the 9th USENIX Symposium on Operating Systems Design and Implementation (OSDI '10), Oct. 4, 2010

### SUMMARY OF THE INVENTION

In a distributed system, the processing speeds of some tasks may be temporarily slow. Its causes range among a failure of a processing server executing the task, a bug in software which is executed on the processing server, the fragmentation of data which is used by a task, congestion in a network to which the processing server is connected, and the like. Here, in order to complete a job, it is necessary to complete all the tasks generated by dividing the job. For that reason, when the progress of some tasks is delayed, the completion of the entire job including these tasks is delayed.

The inventor has found it necessary to consider the processing speed of a task executed on each processing server when determining a processing server to which a new task is allocated. When a new task is allocated to a processing server executing a task the processing speed of which is slow, it can be considered that the processing speed of this newly allocated task will be also slow.

The disclosure of Non-Patent Document 1 relates to a technique for shortening a time required for processing a task which has already been executed, and not to a technique for determining the allocation of a new task. In the technique disclosed in Patent Document 1 or 2, an allocation schedule of tasks is determined on the basis of the load index of tasks and the performance index of a processing server that are measured in advance, and thus a temporary drop in the processing speed of a task is not reflected in the allocation schedule. The technique disclosed in Patent Document 3 is a technique for shortening a time required for the completion of a task that has already been executed, similarly to the technique disclosed in Non-Patent Document 1, and is not a technique for determining a new task. The technique disclosed in Patent Document 4 is a technique for allocating a task on the basis of the performance index value of a processing server that calculated in advance, and the processing speed of a task in execution is not reflected in the allocation of a task. The technique disclosed in Patent Document 5 is a technique for allocating a process to a server and then delaying the start time of the process, and is not a technique for determining the allocation of a task.

The present invention is contrived in view of the above problems. An object of the present invention is to provide a technique in which, when the processing speeds of some tasks are slow in a distributed system, a task allocation is performed so that the processing speeds of other tasks are prevented from being slow.

According to the present invention, there is provided a task allocation determination apparatus that determines an allocation of a task to each of a plurality of servers constituting a distributed system. The task allocation determination apparatus includes: a speed information acquisition unit acquiring speed information, which is information relating to a processing speed of the task which is executed on the server; an abnormality determination unit determining whether or not a processing speed of a task to be determined is abnormal using the speed information; and an allocation exclusion unit temporarily excluding the server from allocation targets of a new task, the server having been allocated the task to be determined of which the processing speed is determined to be abnormal by the abnormality determination unit.

According to the present invention, there is provided a control method which is executed by a computer that determines an allocation of a task to each of a plurality of servers constituting a distributed system. The control method includes: a speed information acquisition step of acquiring speed information, which is information relating to a processing speed of the task which is executed on the server; an abnormality determination step of determining whether or not a processing speed of a task to be determined is abnormal using the speed information; and an allocation exclusion step of temporarily excluding the server from allocation targets of a new task, the server having been allocated the task to be determined the processing speed of which is determined to be abnormal by the abnormality determination step.

According to the present invention, there is provided a program causing a computer to have a function of working as a task allocation determination apparatus according to the present invention. The program causes the computer to have a function included in each functional configuration unit of the task allocation determination apparatus according to the present invention.

According to the present invention, there is provided a technique in which, when the processing speeds of some tasks are slow in a distributed system, a task allocation is performed so that the processing speeds of other tasks are prevented from being slow.

### BRIEF DESCRIPTION OF THE DRAWINGS

The above-mentioned objects, other objects, features and advantages will be made clearer from the preferred exemplary embodiments described below, and the following accompanying drawings.

FIG. 1 is a block diagram illustrating an allocation determination apparatus according to Exemplary embodiment 1 together with its usage environment.

FIG. 2 is a diagram illustrating a configuration of the allocation determination apparatus.

FIG. 3 is a block diagram illustrating a hardware configuration of the allocation determination apparatus according to Exemplary embodiment 1.

FIG. 4 is a flow diagram illustrating a flow of processes executed by the allocation determination apparatus according to Exemplary embodiment 1.

FIG. 5 is a block diagram illustrating an allocation determination apparatus according to Example 1 together with its usage environment.

FIG. 6 is a diagram illustrating a processing server included in a distributed system of Example 1.

FIG. 7 is a diagram illustrating speed information that is stored in speed information storage units of computers c1 and c2.

FIG. 8 is a diagram illustrating speed information that is managed by a speed information management unit.

FIG. 9 is a diagram illustrating speed information that is stored in the speed information storage units of the computers c1 and c2.

FIG. 10 is a diagram illustrating speed information that is managed by the speed information management unit.

FIG. 11 is a diagram illustrating processing progress rates of tasks T1 and T2 per second that are calculated by an abnormality determination unit.

FIG. 12 is a diagram illustrating a configuration of an allocation determination apparatus according to Exemplary embodiment 2.

FIG. 13 is a diagram illustrating a configuration of the allocation determination apparatus according to Exemplary embodiment 2 that includes a normal range calculation unit.

FIG. 14 is a flow diagram illustrating a flow of processes executed by the allocation determination apparatus according to Exemplary embodiment 2.

FIG. 15 is a diagram illustrating a configuration of an allocation determination apparatus according to Exemplary embodiment 3 that includes a normal range calculation unit.

FIG. 16 is a flow diagram illustrating a flow of processes executed by the allocation determination apparatus according to Exemplary embodiment 3.

FIG. 17 is a diagram illustrating a configuration of an allocation determination apparatus according to Exemplary embodiment 4.

FIG. 18 is a flow diagram illustrating a flow of processes executed by the allocation determination apparatus according to Exemplary embodiment 4.

FIG. 19 is a block diagram illustrating an allocation determination apparatus according to Example 2 and its usage environment.

FIG. 20 is a diagram illustrating a processing server included in a distributed system according to Example 2.

FIG. 21 is a diagram illustrating correspondence between a task and a task class in Example 2.

FIG. 22 is a diagram collectively illustrating speed information that is stored in speed information storage units of computers c1 to c3.

FIG. 23 is a diagram illustrating speed information that is managed by a speed information management unit.

FIG. 24 is a diagram collectively illustrating speed information that is stored in the speed information storage units of the computers c1 to c3.

FIG. 25 is a diagram illustrating speed information that is managed by the speed information management unit.

FIG. 26 is a diagram illustrating a progress degree of a task calculated on the basis of the speed information that is acquired from the speed information management unit.

FIG. 27 is a diagram illustrating a configuration of an allocation determination apparatus according to Exemplary embodiment 5.

FIG. 28 is a flow diagram illustrating a flow of processes that are executed by the allocation determination apparatus according to Exemplary embodiment 5.

FIG. 29 is a diagram illustrating a configuration of an allocation determination apparatus according to Exemplary embodiment 6.

FIG. 30 is a flow diagram illustrating a flow of processes executed by the allocation determination apparatus according to Exemplary embodiment 6.

FIG. 31 is a diagram illustrating a configuration of an allocation determination apparatus according to Exemplary embodiment 7.

FIG. 32 is a flow diagram illustrating a flow of processes executed by the allocation determination apparatus according to Exemplary embodiment 7.

FIG. 33 is a diagram illustrating an allocation determination apparatus 2000 according to Example 3 and its usage environment.

FIG. 34 is a diagram collectively illustrating speed information that is stored in speed information storage units 3240 of the computers c1 and c2.

FIG. 35 is a diagram illustrating speed information that is managed by a speed information management unit.

FIG. 36 is a diagram illustrating a progress degree of a task calculated on the basis of the speed information that is acquired from the speed information management unit.

### DESCRIPTION OF EXEMPLARY EMBODIMENTS

Hereinafter, exemplary embodiments of the present invention will be described with reference to the accompanying drawings. In all the drawings, like elements are referenced by like reference numerals and descriptions thereof will not be repeated.

### Exemplary Embodiment 1

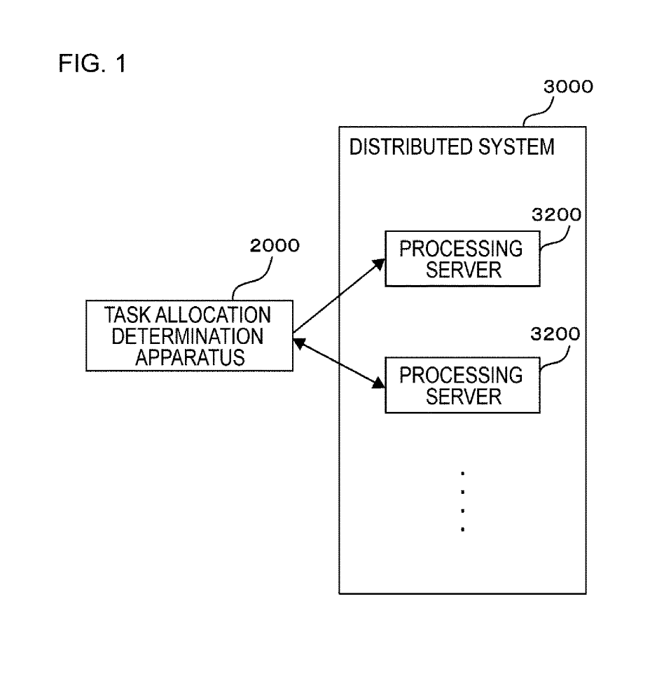

FIG. 1 is a block diagram illustrating an allocation determination apparatus 2000 according to Exemplary embodiment 1 together with its usage environment. In FIG. 1, arrows indicate a flow of information. Further, in FIG. 1, each block represents a function-based block rather than a hardware-based configuration.

A distributed system 3000 includes a plurality of processing servers 3200. A task is allocated to each of the processing servers 3200. The processing server 3200 is a variety of computers such as a server, a personal computer (PC), and a tablet terminal. The processing server 3200 executes an allocated task. The allocation determination apparatus 2000 determines the allocation of a task to the processing server 3200. Specifically, the allocation determination apparatus determines whether or not a processing server 3200 should be temporarily excluded from a target to which a new task may be allocated, on the basis of the processing speed of a task being in execution on the processing server 3200. Similarly to the processing server 3200, the allocation determination apparatus 2000 is a variety of computers. Note that, the number of tasks to be executed on the processing server 3200 may be one, or may be plural.

The processing server 3200 and the allocation determination apparatus 2000 are connected to each other through a network. This network may be a network that is constituted by a wired line, may be a network that is constituted by a wireless line, and may be a network having a mixture of a wired line and a wireless line.

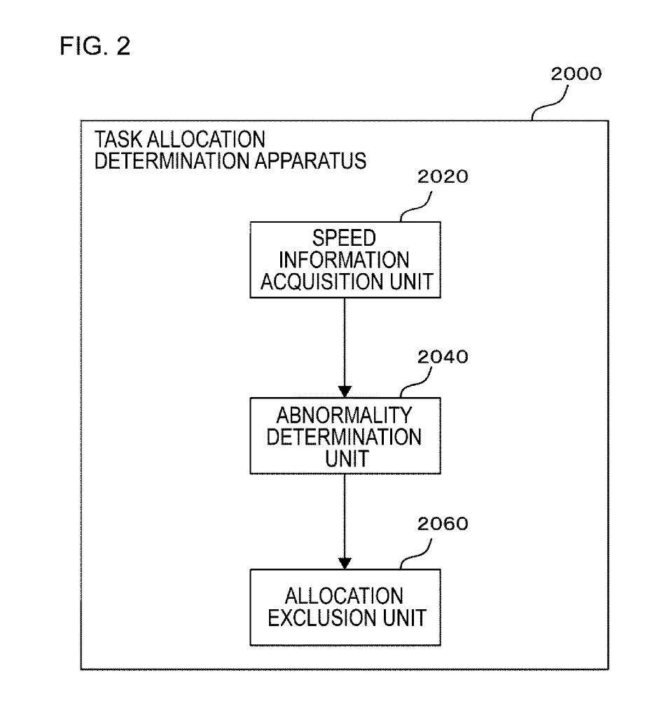

FIG. 2 is a diagram illustrating a configuration of the allocation determination apparatus 2000. In FIG. 2, arrows indicate a flow of information. Further, in FIG. 2, each block represents a function-based block rather than a hardware-based configuration. The allocation determination apparatus 2000 includes a speed information acquisition unit 2020, an abnormality determination unit 2040, and an allocation exclusion unit 2060. Hereinafter, each of the units will be described.

<Speed Information Acquisition Unit 2020>

The speed information acquisition unit 2020 acquires speed information, which is information relating to the processing speed of a task being in execution on the processing server 3200.

<Abnormality Determination Unit 2040>

The abnormality determination unit 2040 determines whether or not the processing speed of a task to be determined (hereinafter, target task) is abnormal using the speed information.

<Allocation Exclusion Unit 2060>

When the processing speed of a target task is determined to be abnormal by the abnormality determination unit 2040, the allocation exclusion unit 2060 temporarily excludes a processing server 3200 to which the target task is allocated, from allocation targets of a new task. Hereinafter, the processing server 3200 that is temporarily excluded from the allocation targets of a new task is denoted by an excluded server. Here, the new task means a task that is allocated to any processing server 3200 after a processing server 3200 executing a target task becomes an excluded server by the determination of the allocation exclusion unit 2060. Therefore, even a task that has been executed on a certain processing server 3200 in the past may be handled as a new task by the processing server 3200 if this task is not currently executed on the processing server 3200.

<Hardware Configuration>

Each functional configuration unit included in the allocation determination apparatus 2000 is implemented with, for example, at least one hardware component in a state where individual or a plurality of units are combined. Furthermore, for example, each functional configuration unit may be implemented with at least one software component. Furthermore, for example, each functional configuration unit may be implemented with a combination of hardware components and software components.

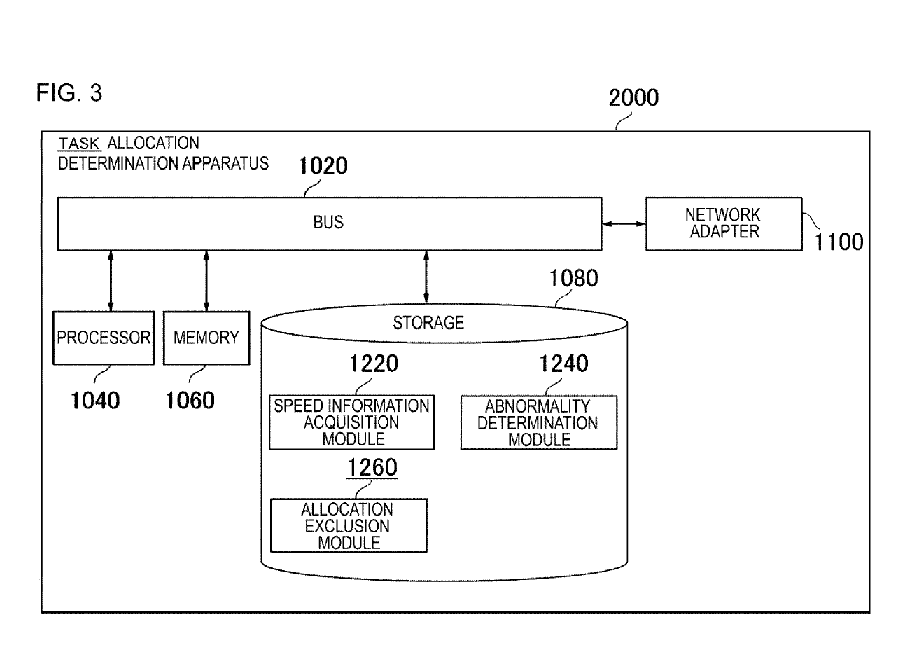

FIG. 3 is a block diagram illustrating a hardware configuration of the allocation determination apparatus 2000 according to Exemplary embodiment 1. In FIG. 3, the allocation determination apparatus 2000 includes a bus 1020, a processor 1040, a memory 1060, a storage 1080, and a network adapter 1100.

The bus 1020 is a data transmission channel in order for the processor 1040, the memory 1060, the storage 1080, and the network adapter 1100 to mutually transmit and receive data. The processor 1040 is an arithmetic processing unit such as, for example, a central processing unit (CPU) or a graphics processing unit (GPU). The memory 1060 is a memory such as, for example, a random access memory (RAM) or a read only memory (ROM). The storage 1080 is a storage apparatus, such as, for example, a memory card, a hard disk, or a solid state drive (SSD). In addition, the storage 1080 may be a memory such as a RAM or a ROM. The network adapter 1100 is an interface in order for the allocation determination apparatus 2000 to perform communication with an external apparatus through a network. The network adapter 1100 may be an interface for connection to a wireless line, and may be an interface for connection to a wired line.

A speed information acquisition module 1220 is a program for causing the allocation determination apparatus 2000 to have a function of the speed information acquisition unit 2020. The processor 1040 realizes the function of the speed information acquisition unit 2020 by executing the speed information acquisition module 1220.

An abnormality determination module 1240 is a program for causing the allocation determination apparatus 2000 to have a function of the abnormality determination unit 2040. The processor 1040 realizes the function of the abnormality determination unit 2040 by executing the abnormality determination module 1240.

An allocation exclusion module 1260 is a program for causing the allocation determination apparatus 2000 to have a function of the allocation exclusion unit 2060. The processor 1040 realizes the function of the allocation exclusion unit 2060 by executing the allocation exclusion module 1260.

For example, the processor 1040 reads out and executes each of the modules on the memory 1060. However, the processor 1040 may execute each of the modules without reading out the modules on the memory 1060.

The storage 1080 stores each of the modules.

The hardware configuration of the allocation determination apparatus 2000 is not limited to the configuration shown in FIG. 3. For example, each of the modules may be stored in the memory 1060. In this case, the allocation determination apparatus 2000 may not include the storage 1080.

<Flow of Processes>

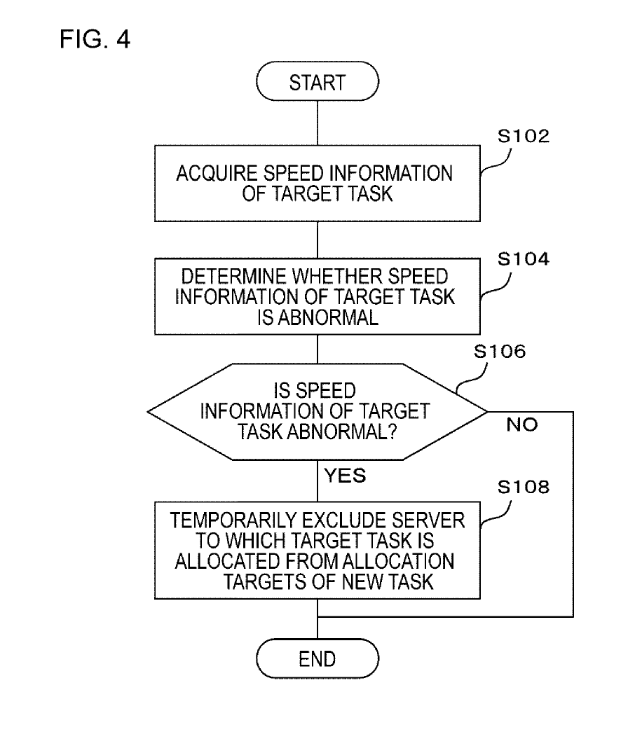

FIG. 4 is a flow diagram illustrating a flow of processes performed by the allocation determination apparatus 2000 according to Exemplary embodiment 1.

In step S102, the speed information acquisition unit 2020 acquires speed information of a target task. In step S104, the abnormality determination unit 2040 determines whether or not the processing speed of a target task is abnormal using the speed information. In step S106, the allocation exclusion unit 2060 determines whether or not the processing speed of a target task has been determined to be abnormal by the abnormality determination unit 2040. When the processing speed of a target task is determined to be abnormal by the abnormality determination unit 2040 (step S106: YES), the process of FIG. 4 proceeds to step S108. On the other hand, when the processing speed of a target task is determined not to be abnormal by the abnormality determination unit 2040 (step S106: NO), the process of FIG. 4 is terminated. In step S108, the allocation exclusion unit 2060 temporarily excludes a server to which a target task is allocated, from allocation targets of a new task.

Hereinafter, the allocation determination apparatus 2000 of the present exemplary embodiment will be described in more detail.

<Details of Speed Information Acquisition Unit 2020>

The speed information acquired by the speed information acquisition unit 2020 is, for example, information directly indicating the processing speed of a task. The processing speed of a task is represented by the progress rate of a task per unit time, the amount of data processed per unit time, the amount of resources used per unit time, the resource utilization, or the like. The resource may be, for example, a CPU, a memory, a disk bandwidth, a network bandwidth, or the like.

In addition, the speed information may be information that can be used in the calculation of the processing speed of a task. In this case, for example, the speed information is indicated by a combination of a time point and the progress degree of a task at the time point. This speed information is used, and thus, for example, the processing speed of a task can be determined by calculating “a difference in the progress degrees of a task divided by a difference in time points”.

The progress degree of a task indicates the progress rate of the task, the ratio of the amount of processed data to the amount of data to be processed, or the like. In addition, for example, the progress degree of a task indicates a cumulative value of the amount of resources used by the task. The progress degree of a task can be predicted by ascertaining how much resource the task has used. Further, the progress degree of a task may be a predicted value of the remaining processing time that is calculated using a mathematical model or the like.

There are various methods in which the speed information acquisition unit 2020 acquires speed information. For example, the speed information acquisition unit 2020 may acquire speed information that is input from an external apparatus or speed information that is manually input. Furthermore, the speed information acquisition unit 2020 may acquire speed information by accessing an external apparatus.

<Details of Abnormality Determination Unit 2040>

There are various methods in which the abnormality determination unit 2040 determines whether or not the processing speed of a target task is abnormal using the speed information. For example, when the speed information directly indicates the processing speed of a task, the abnormality determination unit 2040 determines whether or not the processing speed of a target task is abnormal on the basis of the processing speed indicated by the speed information of the target task. In addition, for example, when the speed information indicates information that can be used in the calculation of the processing speed of a task, the abnormality determination unit 2040 calculates the processing speed of a target task using the speed information of the target task. The abnormality determination unit 2040 determines whether or not the processing speed of a target task is abnormal, on the basis of the calculated processing speed of the target task.

For example, when the processing speed of a target task is less than a predetermined threshold, the abnormality determination unit 2040 determines the processing speed of the target task is abnormal. In addition, for example, the abnormality determination unit 2040 determines that the processing speed of a target task is abnormal when the processing speed thereof is lowest among a plurality of target tasks. In addition, for example, with an assumption of that the distribution of processing speeds of tasks is a normal distribution, the processing speed of a target task is determined to be abnormal when the processing speed of the target task is lower than a reference value to some extent, the reference value being the median value or average value of this normal distribution or the like. Furthermore, for example, with an assumption of that the probability distribution of processing speeds of tasks is a Poisson distribution that is a discrete probability distribution, a chi-square distribution that is a continuous probability distribution, or the like, the processing speed of a target task is determined to be abnormal when the occurrence probability of the processing speed of the target task on the probability distribution is less than a reference value to some extent. Further, for example, it is determined that a task has a low processing speed using a machine learning algorithm such as a K-means method or a support vector machine, and then it is determined that the task determined to have a low processing speed may be a task with an abnormal processing speed.

<Target Task>

There are various methods in which the allocation determination apparatus 2000 determines which task is handled as a target task. For example, the allocation determination apparatus 2000 may randomly select a target task from tasks included in the distributed system 3000. In addition, the allocation determination apparatus 2000 may accept the designation of a target task by an external apparatus or the manual designation of a target task. In addition, the allocation determination apparatus 2000 may acquire information indicating which task is handled as a target task by accessing an external apparatus.

For example, the allocation determination apparatus 2000 periodically processes each task as a target task. In addition, the allocation determination apparatus 2000 may make time intervals different for each task, with which time interval each task is processed as a target task. In that case, information indicating time points or time intervals with which each task is processed as a target task is stored, for example, inside or outside of the allocation determination apparatus 2000.

<Processing Server 3200>

There are various timings at which the processing server 3200 is set to an allocation target of a new task again, which processing server 3200 had been set to an excluded server. For example, the allocation determination apparatus 2000 may determine whether or not the processing speed of a task is abnormal, even for a task being executed on an excluded server. When a processing server 3200 executing a task, the processing speed of which is determined not to be abnormal by the abnormality determination unit 2040, is an excluded server, the allocation exclusion unit 2060 sets the processing server 3200 to an allocation target of a new task. Furthermore, for example, the processing server 3200 may be set to an excluded server for a pre-determined period specified by the allocation exclusion unit 2060. In this case, the allocation determination apparatus 2000 may not need to determine whether or not the processing speed is abnormal with respect to the task executed on the excluded server for the pre-determined period.

<Operational Advantage>

According to the allocation determination apparatus 2000 of the present exemplary embodiment, the processing server 3200 executing a task with an abnormal processing speed is temporarily excluded from the allocation targets of a new task. Here, when anew task is further allocated to the processing server 3200 with an abnormal processing speed of a task, it is expected that the processing speed of the newly allocated task will also become abnormal. As a result, when a delay in the progress of a task increases, the progress of the entire job is consequently delayed. According to the present exemplary embodiment, the processing server 3200 executing a task with an abnormal processing speed is temporarily excluded from the allocation targets of a new task, and thus it is possible to avoid a delay in the processing speed of a newly allocated task.

### Example 1

A specific operation of the allocation determination apparatus 2000 according to Exemplary embodiment 1 will be described with reference to an example. Note that, the following is an example of a behavior of the allocation determination apparatus 2000. The present exemplary embodiment is not limited to the example of the behavior shown below at all.

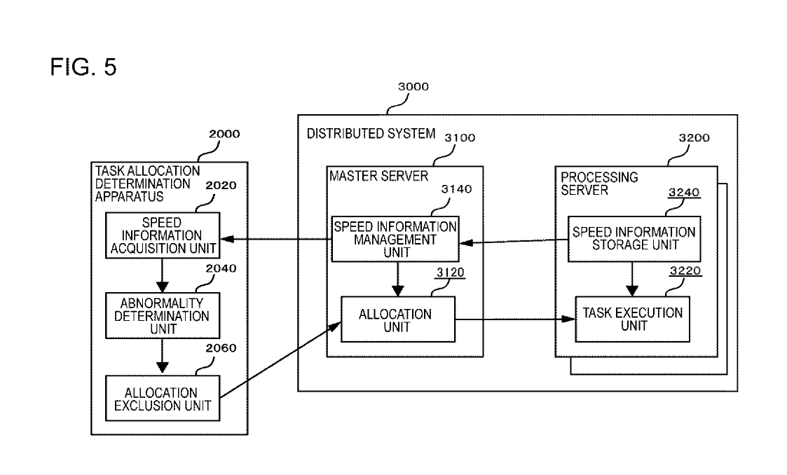

FIG. 5 is a block diagram illustrating the allocation determination apparatus 2000 according to Example 1 together with its usage environment. In FIG. 5, arrows indicate a flow of information. Further, in FIG. 5, each block represents a function-based block rather than a hardware-based configuration.

In Example 1, the distributed system 3000 includes a master server 3100. The master server 3100 includes an allocation unit 3120 and a speed information management unit 3140. The allocation unit 3120 allocates a task to the processing server 3200. The speed information management unit 3140 collects speed information from each processing server 3200, and manages the speed information. In the present example, the speed information indicates a processing progress rate of a task.

The processing server 3200 includes a task execution unit 3220 and a speed information storage unit 3240. The task execution unit 3220 executes one or a plurality of tasks. For example, the task execution unit 3220 is a process, a thread, a virtual machine, or the like. The processing server 3200 may include a plurality of task execution units 3220. The speed information storage unit 3240 stores speed information relating to a task being in execution on the processing server 3200.

The speed information acquisition unit 2020 of Example 1 acquires speed information of each task from the speed information management unit 3140. The abnormality determination unit 2040 determines whether or not the processing speed of a task is abnormal using the speed information acquired from the speed information acquisition unit 2020.

The allocation exclusion unit 2060 of Example 1 notifies the allocation unit 3120 of a determination result of whether or not the processing server 3200 is temporarily excluded from the allocation targets of a new task. In this manner, the allocation unit 3120 is configured not to allocate a task to the processing server 3200 that is temporarily excluded from the allocation targets of a new task.

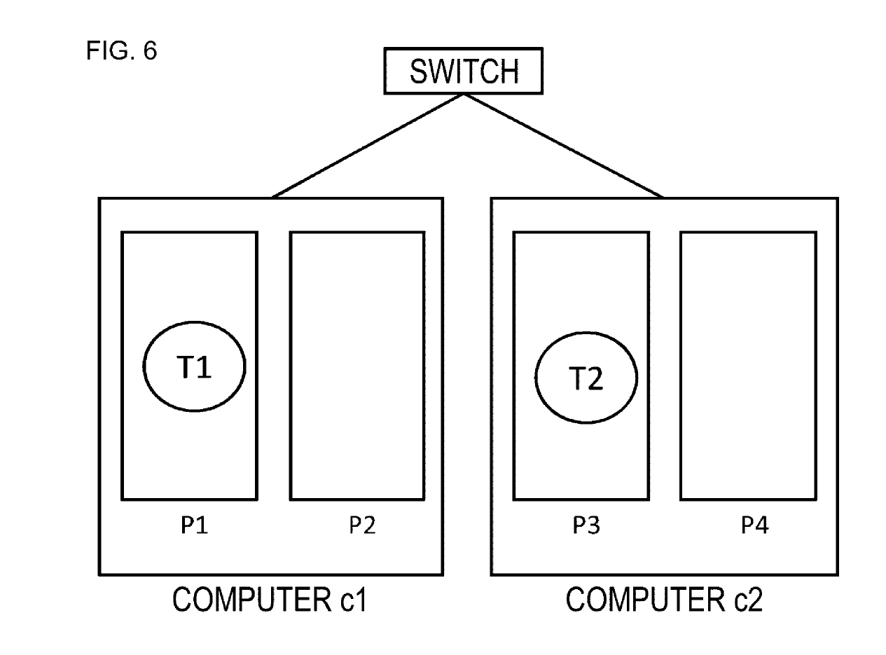

FIG. 6 is a diagram illustrating the processing server 3200 included in the distributed system 3000 of Example 1. The distributed system 3000 of Example 1 includes computers c1 and c2 as the processing servers 3200. The computers c1 and c2 are connected to each other through a network switch. The computer c1 includes processes P1 and P2 as the task execution units 3220. In addition, the computer c2 includes processes P3 and P4 as the task execution units 3220. The process P1 executes a task T1, and the process P3 executes a task T2. Note that, in FIG. 6, the master server 3100 and the speed information storage unit 3240 are omitted.

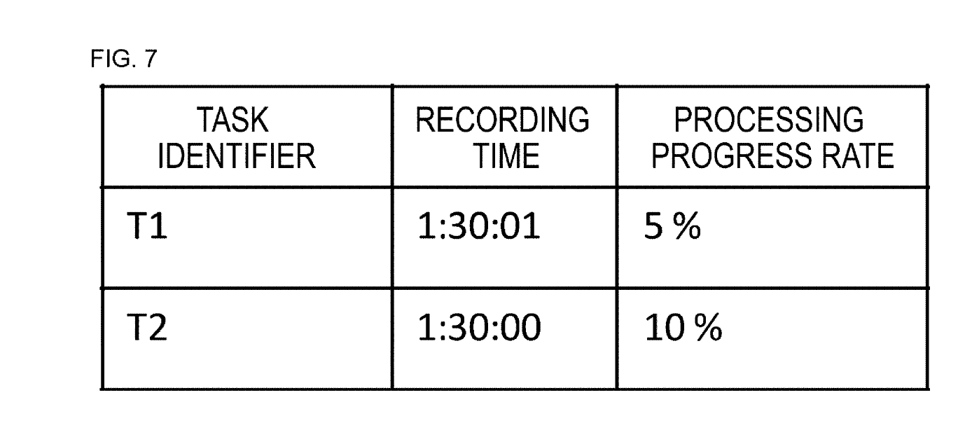

The computers c1 and c2 monitor the state of a task in execution, generates speed information relating to the task in execution, and stores the speed information in the speed information storage unit 3240. FIG. 7 is a diagram illustrating the speed information stored in the speed information storage units 3240 of the computers c1 and c2. Here, the speed information in the present example indicates a processing progress rate of a task. For example, a record of a first row in FIG. 7 indicates that the processing progress rate of task T1 is 5% at time 1:30:01.

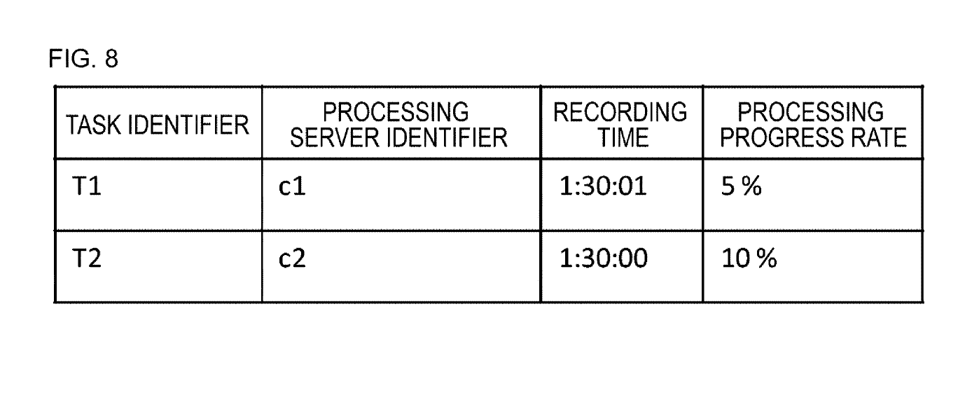

The speed information stored in the speed information storage units 3240 of the computers c1 and c2 is collected by the speed information management unit 3140 included in the master server 3100. FIG. 8 is a diagram illustrating speed information managed by the speed information management unit 3140. For example, a record of a first row in FIG. 8 indicates that the task T1 is executed in the computer c1, and that the processing progress rate of the task T1 is 5% at a time point of time 1:30:01. In addition, a record of a second row indicates that the task T2 is executed in the computer c2, and that the processing progress rate of the task T2 is 10% at the time point of time 1:30:00.

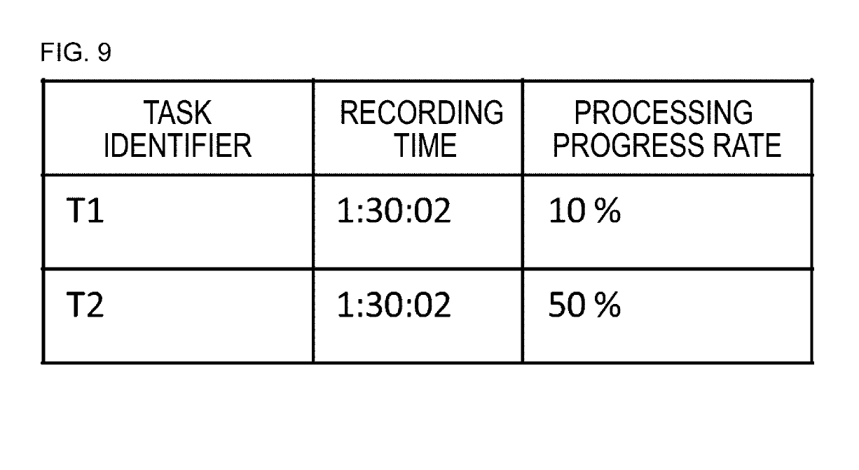

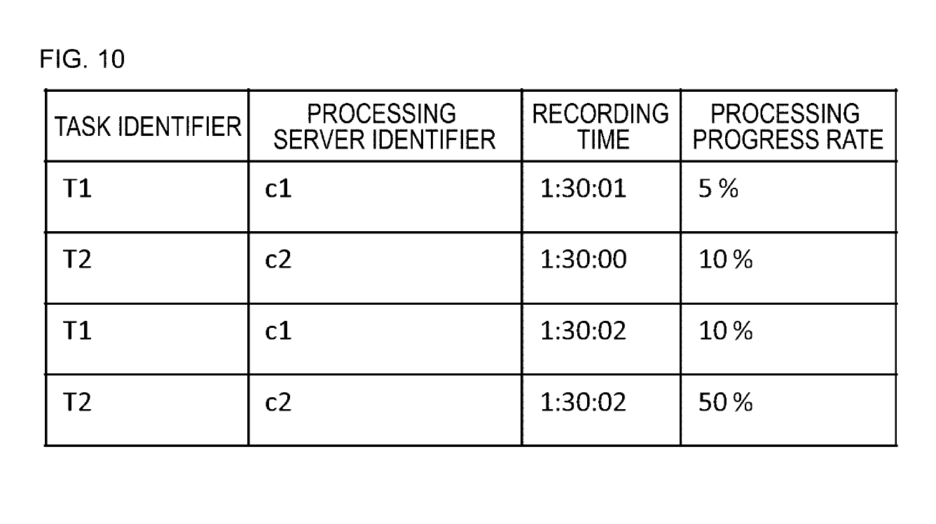

The computers c1 and c2 continue to further execute tasks, and further generate speed information. FIG. 9 is a diagram illustrating speed information stored in the speed information storage units 3240 of the computers c1 and c2 at this time point. The speed information shown in FIG. 9 is collected by the speed information management unit 3140. FIG. 10 illustrates speed information managed by the speed information management unit 3140.

In Example 1, the computer c1 executes the task T1, and the computer c2 executes the task T2. In addition, the computer c1 includes the process P3 to which a task is not allocated, and the computer c2 includes the process P4 to which a task is not allocated. Thus, the master server 3100 tries to allocate a new task T3 to any of the computers c1 and c2. To do so, the allocation unit 3120 of the master server 3100 uses a determination result of the allocation determination apparatus 2000.

Processes performed by the allocation determination apparatus 2000 will be described below. The speed information acquisition unit 2020 acquires speed information relating to the tasks T1 and T2 from the speed information management unit 3140. Specifically, the speed information acquisition unit 2020 acquires information shown in FIG. 10.

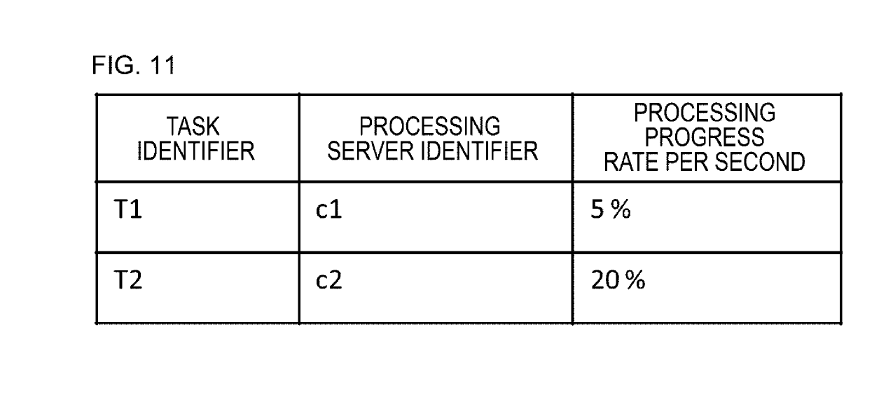

In the present example, the abnormality determination unit 2040 calculates a processing progress rate of a task per second using the speed information acquired from the speed information acquisition unit 2020, and sets a calculated value to the processing speed of a task. FIG. 11 illustrates processing progress rates of the tasks T1 and T2 per second that are calculated by the abnormality determination unit 2040 on the basis of the speed information. FIG. 11 indicates that the processing progress rate of task T1 per second allocated to the computer c1 is 5%, and that the processing progress rate of the task T2 per second allocated to the computer c2 is 20%.

The abnormality determination unit 2040 determines that the processing speed of a task having a lowest processing speed among a plurality of tasks is abnormal. In the present example, the abnormality determination unit 2040 determines that the processing speed of the task T1 is abnormal. Thus, the allocation exclusion unit 2060 temporarily excludes the computer c1 executing the task T1 from the allocation targets of a new task. Then, the allocation unit 3120 allocates the task T3 not to the process P3 of the computer c1, but to the process P4 of the computer c2.

### Exemplary Embodiment 2

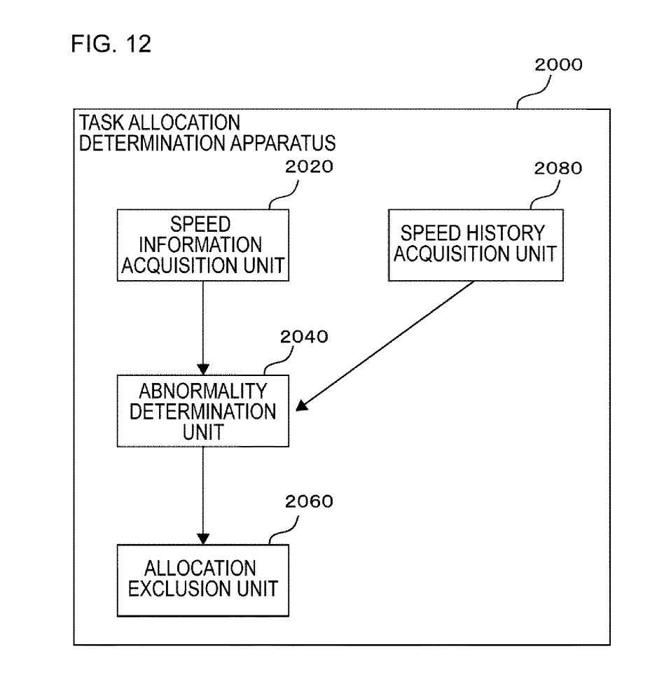

FIG. 12 is a diagram illustrating a configuration of an allocation determination apparatus 2000 according to Exemplary embodiment 2. In FIG. 12, arrows indicate a flow of information. Further, in FIG. 12, each block represents a function-based block rather than a hardware-based configuration. Except for the following description, the allocation determination apparatus 2000 of Exemplary embodiment 2 is the same as the allocation determination apparatus 2000 of Exemplary embodiment 1.

The allocation determination apparatus 2000 of Exemplary embodiment 2 determines whether or not the processing speed of a target task is abnormal, on the basis of the history of the processing speed of the target task. For that reason, the allocation determination apparatus 2000 of Exemplary embodiment 2 includes a speed history acquisition unit 2080. Hereinafter, the detailed description thereof will be given.

<Speed History Acquisition Unit 2080>

The speed history acquisition unit 2080 acquires a speed history, which is a history of the processing speed of a task. For example, the speed history is information indicating the past processing speed of a task. In addition, for example, the speed history may be information that can be used for calculating the past processing speed of a task.

Furthermore, for example, the speed history may be a value indicating a result of performing statistical processing on a variation in the past processing speed. For example, in this case, the speed history is the average value, median value, minimum value, maximum value, mode value, or the like of the processing speed calculated from processing speeds at a plurality of past time points.

There are various methods in which the speed history acquisition unit 2080 acquires a speed history. For example, the speed history acquisition unit 2080 may acquire a speed history that is input from an external apparatus or a speed history that is manually input. Furthermore, the speed history acquisition unit 2080 may acquire a speed history by accessing an external apparatus.

<Abnormality Determination Unit 2040>

The abnormality determination unit 2040 of Exemplary embodiment 2 determines whether or not the processing speed of a target task is abnormal by comparing the processing speed of the target task with the speed history of the target task. For example, the abnormality determination unit 2040 determines the processing speed of a target task to be abnormal when the processing speed of the target task is lower than a statistical value of the past processing speed calculated with the speed history or a statistical value of the past processing speed indicated as the speed history.

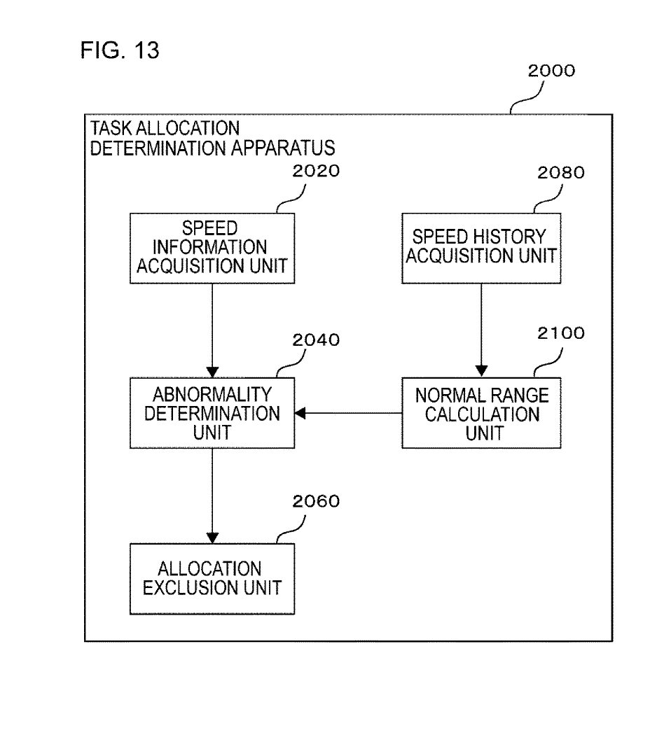

Furthermore, for example, the abnormality determination unit 2040 works as follows. In this case, as shown in FIG. 13, the allocation determination apparatus 2000 further includes a normal range calculation unit 2100. Here, in FIG. 13, arrows indicate a flow of information. Further, in FIG. 13, each block represents a function-based block rather than a hardware-based configuration.

The normal range calculation unit 2100 calculates a normal speed range, which is a normal range of the processing speed of a target task, on the basis of the speed history of the target task. In this case, the abnormality determination unit 2040 determines the processing speed of a target task to be abnormal when the processing speed of the target task is not included in the normal speed range.

The normal range calculation unit 2100 calculates a probability distribution of the past processing speed, for example, shown in the speed history. The normal range calculation unit 2100 handles a predetermined range in the probability distribution as the normal speed range.

<Flow of Processes>

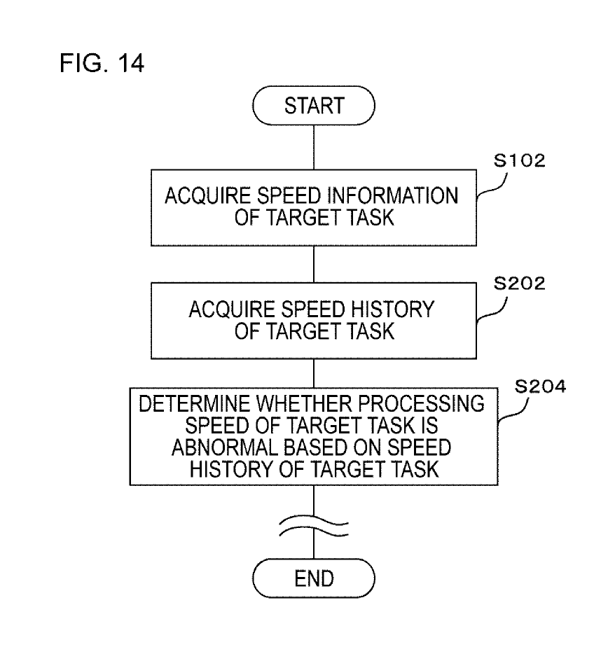

FIG. 14 is a flow diagram illustrating a flow of processes executed by the allocation determination apparatus 2000 of Exemplary embodiment 2. After step S204, the allocation determination apparatus 2000 of Exemplary embodiment 2 executes processes of steps S106 and S108 shown in FIG. 4, similarly to the allocation determination apparatus 2000 of Exemplary embodiment 1. For the purpose of simplifying the drawing, steps S106 and S108 are omitted in FIG. 14.

In step S202, the speed history acquisition unit 2080 acquires the speed history of a target task. In step S204, the abnormality determination unit 2040 determines whether or not the processing speed of the target task is abnormal by comparing the processing speed of the target task with the speed history of the target task.

<Operational Advantages>

The allocation determination apparatus 2000 of the present exemplary embodiment determines whether or not the processing speed of a target task is abnormal, using the history of the processing speed of the target task. Therefore, according to the allocation determination apparatus 2000 of the present exemplary embodiment, it is possible to detect that the processing speed of a target task is abnormal when the processing speed of the target task changes abnormally as compared to the past. By doing so, it is possible with a high level of accuracy to prevent the processing speed of a newly added task from being slow.

### Exemplary Embodiment 3

The configuration of an allocation determination apparatus 2000 according to Exemplary embodiment 3 is the same as, for example, the allocation determination apparatus of Exemplary embodiment 1 or the allocation determination apparatus 2000 of Exemplary embodiment 2. Except for the following description, the allocation determination apparatus 2000 of Exemplary embodiment 3 is the same as the allocation determination apparatus 2000 of Exemplary embodiment 1 or 2.

The abnormality determination unit 2040 of Exemplary embodiment 3 determines whether or not the processing speed of a target task is abnormal by comparing the processing speed of the target task with the processing speed of a task other than the target task. For example, the speed information acquisition unit 2020 may acquire speed information relating to a target task and speed information relating to a task other than the target task. The abnormality determination unit 2040 compares the processing speed of the target task with the processing speeds of other tasks, using the speed information of each task.

Here, the number of target tasks may be plural. In this case, for example, the abnormality determination unit 2040 compares each target task with the other target tasks. In this manner, the abnormality determination unit 2040 determines whether or not the processing speed of each of a plurality of target tasks is abnormal.

For example, when the processing speed of a target task is lower than the processing speeds of all other tasks that are compared therewith each other, the abnormality determination unit 2040 may determine the processing speed of the target task to be abnormal. Furthermore, for example, when tasks to be compared are sorted in descending order of processing speed, the abnormality determination unit 2040 may determine the processing speed of a target task is abnormal if the processing speed of the target task is equal to or lower than a predetermined rank.

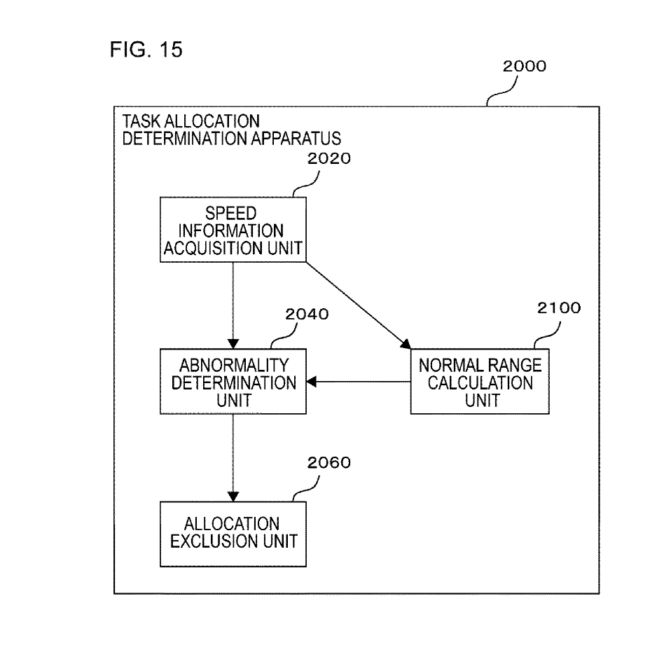

Furthermore, for example, the abnormality determination unit 2040 may work as follows. In this case, as shown in FIG. 15, the allocation determination apparatus 2000 further includes a normal range calculation unit 2100. Here, in FIG. 15, arrows indicate a flow of information. Further, in FIG. 15, each block represents a function-based block rather than a hardware-based configuration.

The normal range calculation unit 2100 calculates a normal speed range, which is a normal range of the processing speed of a target task. For example, the normal range calculation unit 2100 may calculate the normal speed range on the basis of the processing speeds of one or a plurality of tasks other than the target task. Furthermore, for example, the normal range calculation unit 2100 may calculate the normal speed range on the basis of the processing speeds of a plurality of tasks including the target task. In this case, the abnormality determination unit 2040 determines the processing speed of a target task is abnormal when the processing speed of the target task is not included in the normal speed range.

For example, the normal range calculation unit 2100 may calculate a probability distribution of the processing speeds of tasks using the processing speed of tasks used for the calculation of the normal speed range. The normal range calculation unit 2100 handles a predetermined range in the probability distribution as the normal speed range.

<Flow of Processes>

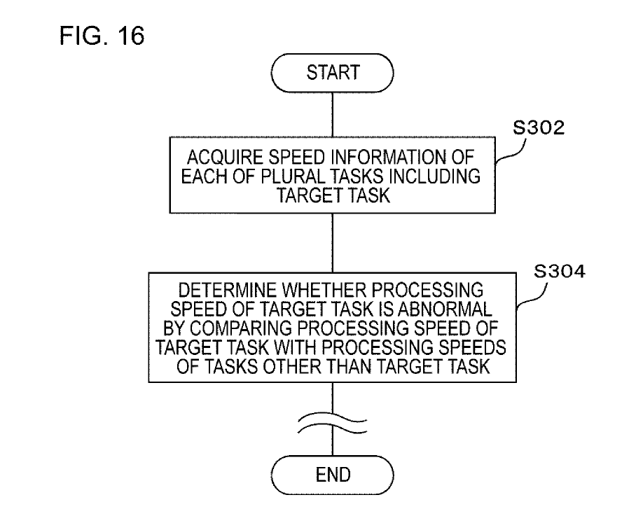

FIG. 16 is a flow diagram illustrating a flow of processes executed by the allocation determination apparatus 2000 of Exemplary embodiment 3. After step S304, the allocation determination apparatus 2000 of Exemplary embodiment 3 executes processes of steps S106 and S108 shown in FIG. 4, similarly to the allocation determination apparatus 2000 of Exemplary embodiment 1. For the purpose of simplifying the drawing, steps S106 and S108 are omitted in FIG. 16.

In step S302, the speed information acquisition unit 2020 acquires speed information of each of a plurality of tasks including the target task. In step S304, the abnormality determination unit 2040 compares the processing speed of the target task with the processing speeds of other tasks, thereby determining whether or not the processing speed of the target task is abnormal.

<Operational Advantages>

According to the present exemplary embodiment, the processing speed of a target task is compared with the processing speed of a task other than the target task, and thus it is determined whether or not the processing speed of the target task is abnormal. By doing so, a task with the processing speed being abnormal as compared to other tasks is determined, and thus the processing server 3200 executing the task can be temporarily excluded from the allocation targets of a new task. Therefore, it is possible with a high level of accuracy to prevent the processing speed of a newly allocated task from being slow.

### Exemplary Embodiment 4

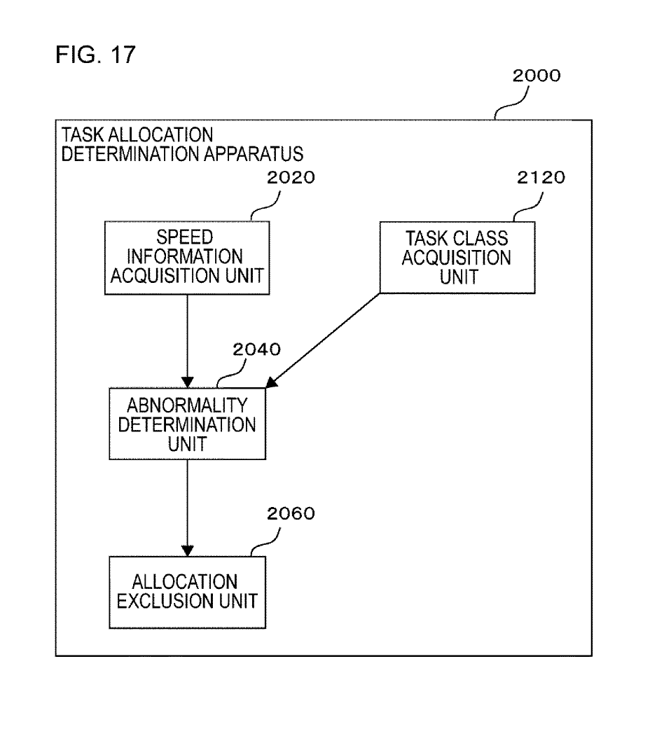

FIG. 17 is a diagram illustrating a configuration of an allocation determination apparatus 2000 according to Exemplary embodiment 4. In FIG. 17, arrows indicate a flow of information. Further, in FIG. 17, each block represents a function-based block rather than a hardware-based configuration. Except for the following description, the allocation determination apparatus 2000 of Exemplary embodiment 4 is the same as the allocation determination apparatus 2000 of Exemplary embodiment 3.

In Exemplary embodiment 4, a task class is associated with each task. The task class is represented by, for example, an ID of a job. For example, each task is associated with the ID of a base job of the task. However, the task class may be other than the ID of a job. For example, the other task classes may be the ID of the phase of a job, or may be a combination of the ID of a job and the ID of a phase, and the like.

The allocation determination apparatus 2000 of Exemplary embodiment 4 includes a task class acquisition unit 2120. The task class acquisition unit 2120 acquires a task class corresponding to a task.

The abnormality determination unit 2040 of Exemplary embodiment 4 compares a target task to be determined with other tasks corresponding to the same task class as that of the target task to be determined. In this manner, the abnormality determination unit 2040 determines whether or not the processing speed of the target task to be determined is abnormal. For example, when the allocation determination apparatus 2000 includes a normal range calculation unit 2100, the normal range calculation unit 2100 uses tasks corresponding to the same task class as that of the target task to be determined for the calculation of the normal speed range. Note that, a method in which the abnormality determination unit 2040 of Exemplary embodiment 4 compares the processing speeds of a plurality of tasks is the same as the method which is performed by the abnormality determination unit 2040 of Exemplary embodiment 3.

<Flow of Processes>

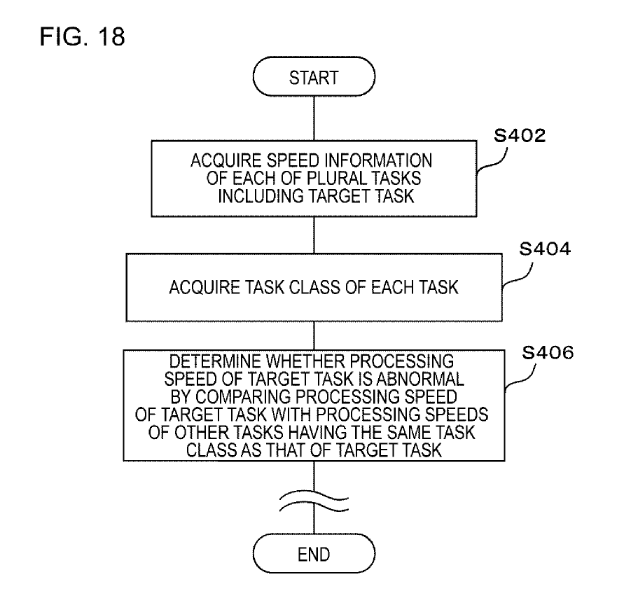

FIG. 18 is a flow diagram illustrating a flow of processes executed by the allocation determination apparatus 2000 of Exemplary embodiment 4. After the process of step S404 is performed, the allocation determination apparatus 2000 of Exemplary embodiment 4 executes steps S106 and S108 shown in FIG. 4, in the same flow as that in the allocation determination apparatus 2000 of Exemplary embodiment 1. For the purpose of simplifying the drawing, step S106 and the subsequent steps are omitted in FIG. 18.

In step S402, the speed information acquisition unit 2020 acquires speed information of each of a plurality of tasks including the target task. In step S404, the task class acquisition unit 2120 acquires a task class of each task. In step S406, the abnormality determination unit 2040 compares the processing speed of the target task with the processing speeds of other tasks having the same task class as that of the target task, using the speed information, and determines whether or not the processing speed of the target task is abnormal.

<Operational Advantages>

According to the present exemplary embodiment, the processing speeds of tasks included in the same task class are compared with each other, and the determination of whether or not the processing speed of a task is abnormal is performed. Here, it is expected that the processing speeds of the tasks included in the same task class are normally close to each other in many cases. Therefore, according to the present exemplary embodiment, it is possible with a high level of accuracy to determine whether or not the processing speed of a task is abnormal.

In addition, according to the present exemplary embodiment, the processing server 3200 in which the processing speed of a task is determined to be abnormal is configured not to be allocated a new task corresponding to the same task class as that of the task. Here, even when the processing speed of a task corresponding to a certain task class is abnormal on a certain processing server 3200, the processing speeds of tasks corresponding to the other task classes may not be abnormal. This is because the characteristics of processes to be executed, such as a resource to be used or the amount of data to be processed, may be different depending on the kind of task. Therefore, according to the present exemplary embodiment, the processing server 3200 in which the processing speed of only a task corresponding to a specific task class is abnormal is not excluded from an allocation targets with respect to the allocation of tasks corresponding to the other task classes. Therefore, it is possible to efficiently use the processing server 3200.

### Example 2

A specific operation of the allocation determination apparatus 2000 according to Exemplary embodiment 4 will be described with reference to an example. Note that, the following is an example of a behavior of the allocation determination apparatus 2000. The present exemplary embodiment is not limited to the example of the behavior shown below at all.

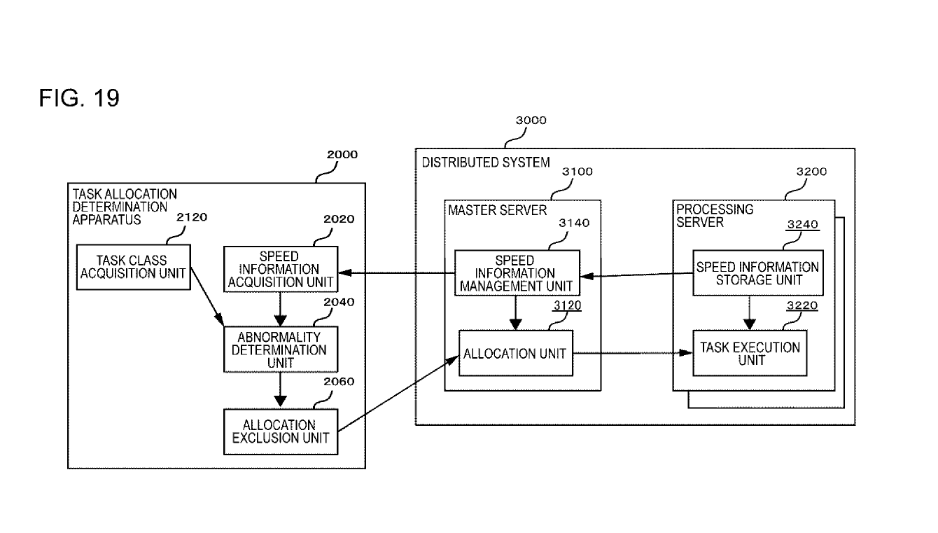

FIG. 19 is a block diagram illustrating an allocation determination apparatus 2000 in Example 2 and its usage environment. Note that, the configuration of a distributed system 3000 in FIG. 19 is the same as the configuration of the distributed system 3000 in Example 1 shown in FIG. 5. In addition, the configuration of an allocation determination apparatus 2000 in FIG. 19 is the same as the configuration of the allocation determination apparatus of Exemplary embodiment 4 shown in FIG. 17.

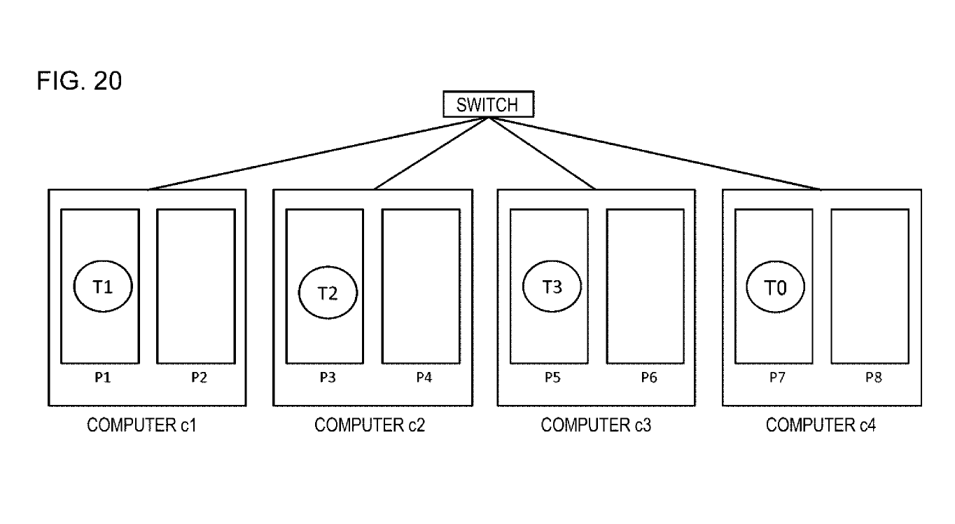

FIG. 20 is a diagram illustrating a processing server 3200 included in a distributed system 3000 of Example 2. The distributed system 3000 of Example 2 includes four computers c1 to c4 as the processing servers 3200. The respective computers are connected to each other through a network switch. Each computer includes a plurality of processes as the processing servers 3200. Specifically, the computer c1 includes processes P1 and P2, the computer c2 includes processes P3 and P4, the computer c3 includes processes P5 and P6, and computer c4 includes processes P7 and P8. Note that, in FIG. 20, the master server 3100 and the speed information storage unit 3240 are omitted.

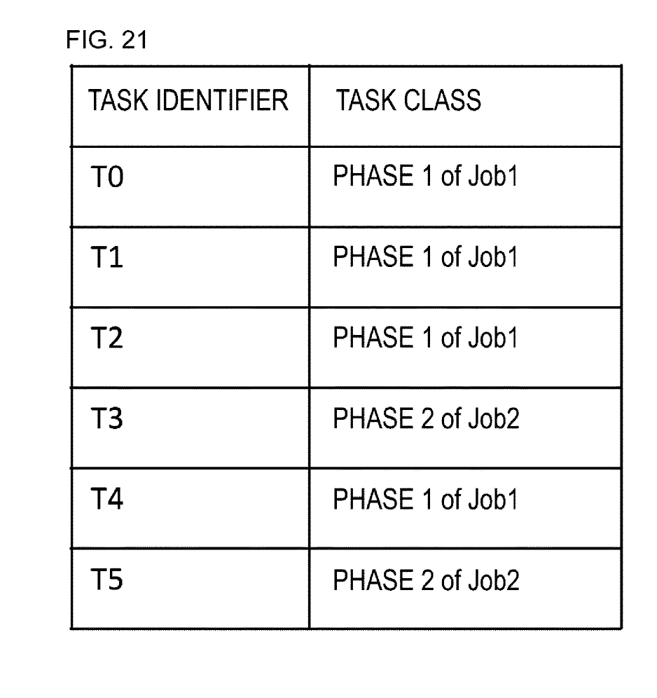

In Example 2, a task class is associated with each task. FIG. 21 is a diagram illustrating correspondence between a task and a task class in Example 2. For example, a record of a first row in FIG. 21 indicates that a task class such as a “phase 1 of Job1” is associated with a task T0.

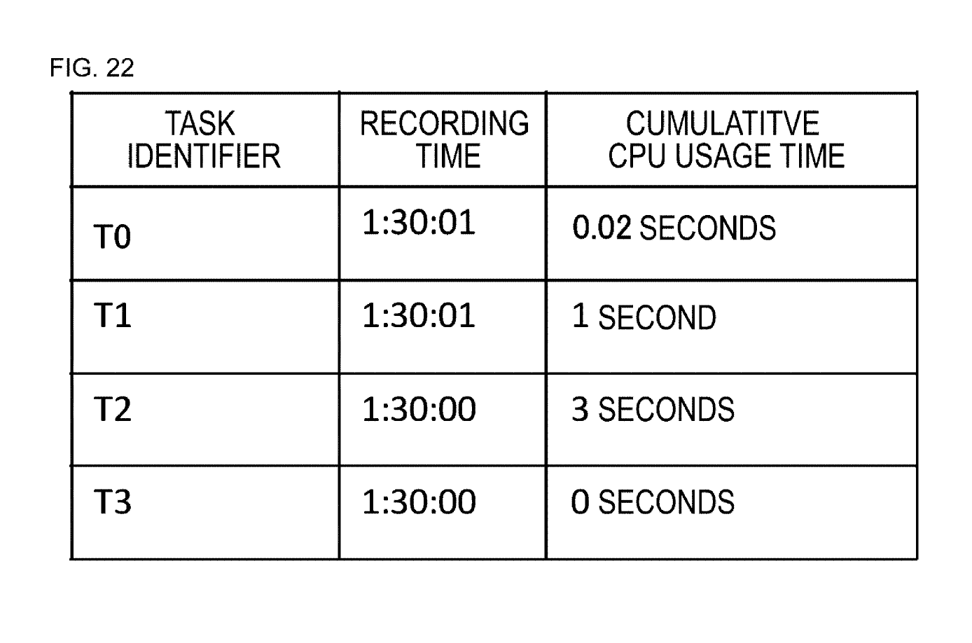

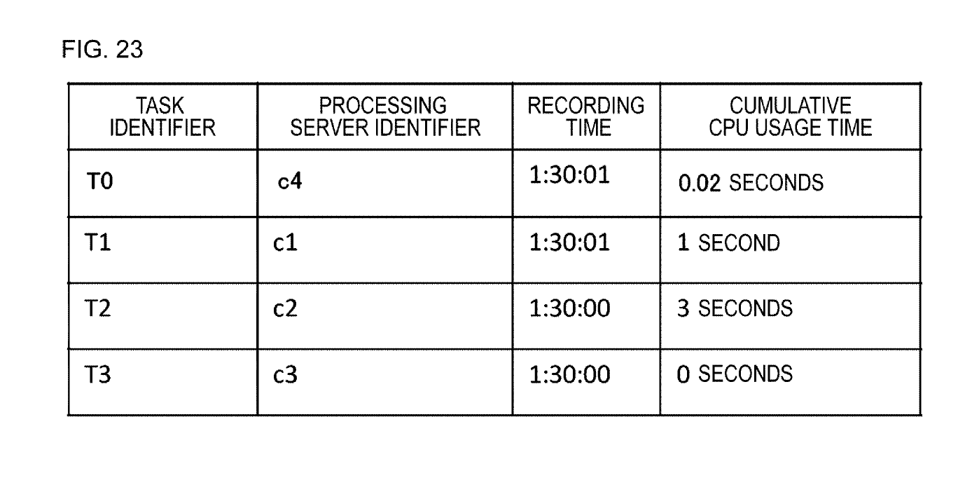

Similarly to Example 1, each computer monitors the state of a task in execution, generates speed information relating to the task in execution, and stores the speed information in the speed information storage unit 3240. FIG. 22 is a diagram collectively illustrating speed information stored in the speed information storage units 3240 of the computers c1 to c3. Here, the speed information in the present example indicates a cumulative CPU usage time. For example, a record of a first row in FIG. 22 indicates that the cumulative CPU usage time of the task T0 is 0.02 seconds at time 1:30:01. The speed information stored in each computer is collected by the speed information management unit 3140. FIG. 23 is a diagram illustrating speed information managed by the speed information management unit 3140.

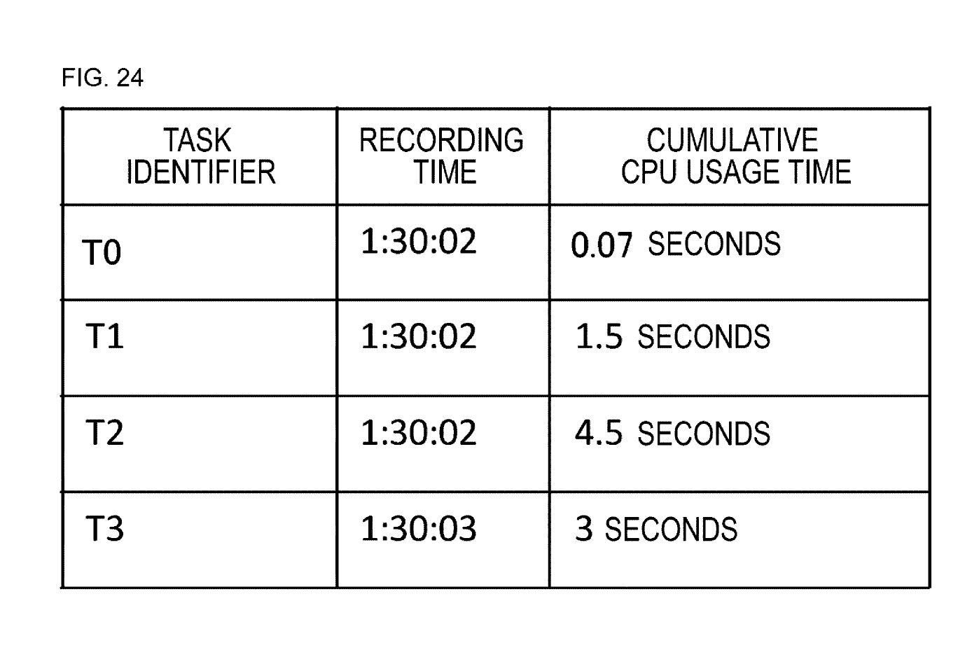

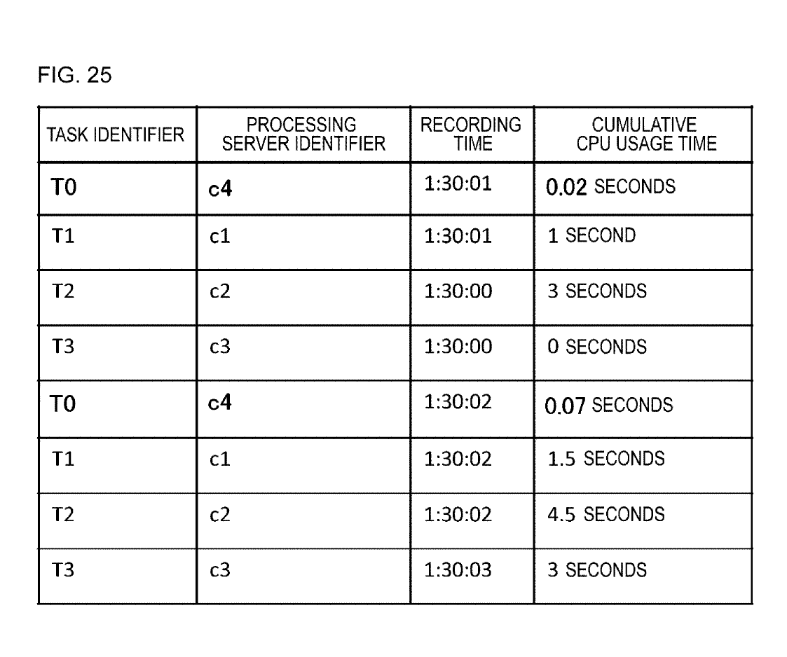

The task execution unit of each computer further proceeds to the execution of a task, generates new speed information, and stores the speed information in the speed information storage unit 3240. FIG. 24 is a diagram collectively illustrating speed information stored in the speed information storage units 3240 of the computers c1 to c3 after the new speed information is stored. FIG. 25 is a diagram illustrating speed information managed by the speed information management unit 3140.

Here, the master server 3100 is configured to allocate a new task T4 to the processing server 3200. Thus, the allocation unit 3120 provides the task T4 to the allocation determination apparatus 2000, as an input. The allocation unit 3120 acquires information indicating a computer, from the allocation determination apparatus 2000, that corresponds to the same task class as that of the task T4 and that is temporarily excluded from the allocation targets of a new task.

The task class acquisition unit 2120 of the allocation determination apparatus 2000 acquires a task class of each task. Thereby, the allocation determination apparatus 2000 ascertains that the task classes of tasks T0, T1, T2, and T4 are the phase 1 of Job1, and the task classes of tasks T3 and T5 are the phase 2 of Job2.

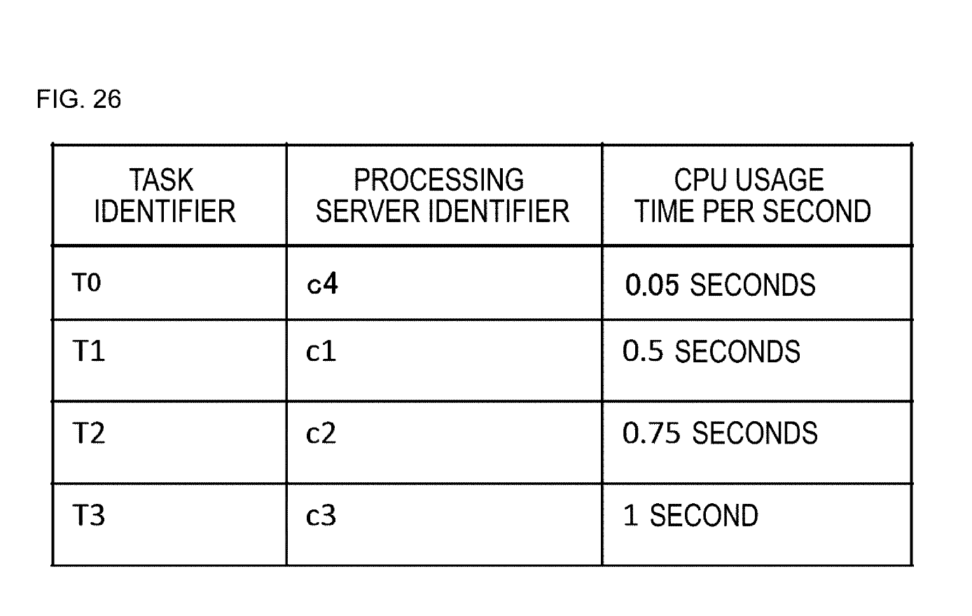

FIG. 26 is a diagram illustrating the processing speed of a task calculated by the abnormality determination unit 2040 on the basis of the speed information. The allocation determination apparatus 2000 in the present behavior example uses a CPU usage time per second, as the processing speed of a task. For example, a record of a first row in FIG. 26 indicates that the CPU usage time per second of the task T0 allocated to the computer c4 is 0.05 seconds.

The abnormality determination unit 2040 performs a process on tasks having the same task class as that of the task T4 that is newly allocated. Here, from FIG. 21, the tasks corresponding to the same task class as that of the task T4 are tasks T0, T1, and T2.

The abnormality determination unit 2040 of the present example obtains a median value μ and a standard deviation σ, using the processing speed of a task corresponding to the same task class. When the processing speed of a task is smaller than an index value “μ−ασ”, the processing speed of the task is determined to be abnormal.

So, the abnormality determination unit 2040 obtains a median value and a standard deviation from the processing speeds of the tasks T0, T1, and T2. The results of the calculation are that the median value μ is 0.43 seconds, and the standard deviation σ is approximately 0.29. Here, when the relation of α=1.0 is established, the above index value is 0.14. Referring to FIG. 26, the processing speed of the task T0 is smaller than this index value, and the processing speeds of the tasks T1 and T2 are larger than this index value.

Therefore, the allocation exclusion unit 2060 removes the computer c4 executing the task T0 from a target to which a new task corresponding to a task class of “phase 1 of job1” is allocated. The allocation unit 3120 receives a notification of a processing result from the allocation determination apparatus 2000, and allocates the task T4 corresponding to the task class of the “phase 1 of job1” to a computer other than the computer c4.

### Exemplary Embodiment 5

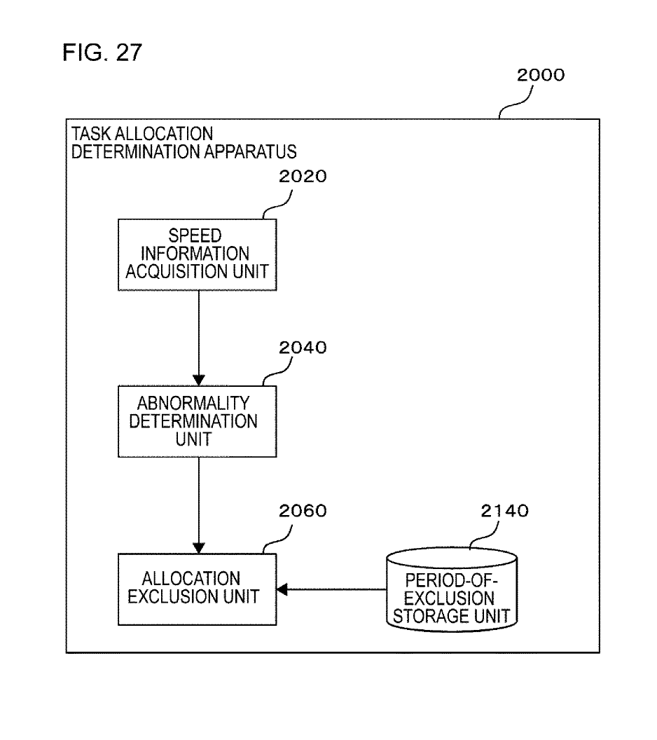

FIG. 27 is a diagram illustrating a configuration of an allocation determination apparatus 2000 according to Exemplary embodiment 5. In FIG. 27, arrows indicate a flow of information. Further, in FIG. 27, each block represents a function-based block rather than a hardware-based configuration. Except for the following description, the allocation determination apparatus 2000 of Exemplary embodiment 5 is the same as the allocation determination apparatus 2000 of any of the aforementioned exemplary embodiments.

<Period-of-Exclusion Storage Unit 2140>

The allocation determination apparatus 2000 includes a period-of-exclusion storage unit 2140. The period-of-exclusion storage unit 2140 stores a period of exclusion. The period of exclusion indicates a period in which the processing server 3200 allocated a target task is temporarily excluded from the allocation targets of a new task.

<Allocation Exclusion Unit 2060>

When the processing speed of a target task is determined to be abnormal by the abnormality determination unit 2040, the allocation exclusion unit 2060 of Exemplary embodiment 5 excludes the processing server 3200 to which a target task is allocated, from the allocation targets of a new task, during the period of exclusion.

<Flow of Processes>

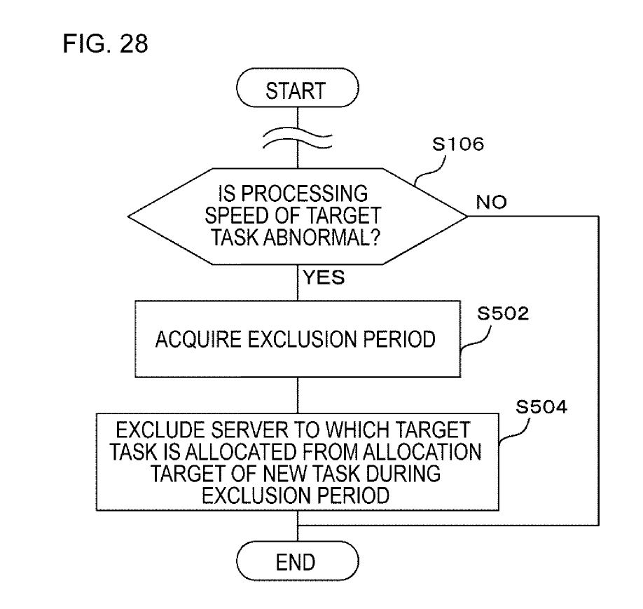

FIG. 28 is a flow diagram illustrating a flow of processes executed by the allocation determination apparatus 2000 of Exemplary embodiment 5. The allocation determination apparatus 2000 of Exemplary embodiment 5 executes the processes of steps S102 to S106 shown in FIG. 4, in the same flow as that in the allocation determination apparatus 2000 of Exemplary embodiment 1. For the purpose of simplifying the drawing, steps S102 and S104 are omitted in FIG. 28.

In step S502, the allocation exclusion unit 2060 acquires a period of exclusion from the period-of-exclusion storage unit 2140. In step S504, the allocation exclusion unit 2060 temporarily excludes the processing server 3200 to which a target task is allocated, from the allocation targets of anew task, during the period of exclusion.

<Operational Advantages>

According to the allocation determination apparatus 2000 of the present exemplary embodiment, the processing server 3200 executing a target task, the processing speed of which is determined to be abnormal by the abnormality determination unit 2040, is excluded from the allocation target of a new task during the period of exclusion. Therefore, according to the allocation determination apparatus 2000 of the present exemplary embodiment, the determination of whether or not the processing speed is abnormal may not be performed for the task executed on the processing server 3200 during the period of exclusion. Therefore, according to the allocation determination apparatus 2000 of the present exemplary embodiment, a processing load on the allocation determination apparatus 2000 is reduced.

Note that, the period-of-exclusion storage unit 2140 may store a period of exclusion for each processing server 3200. In this manner, it is possible to set an appropriate period of exclusion for each processing server 3200, in consideration of the characteristics of the processing server 3200 or the characteristics of a task executed on the processing server 3200.

### Exemplary Embodiment 6

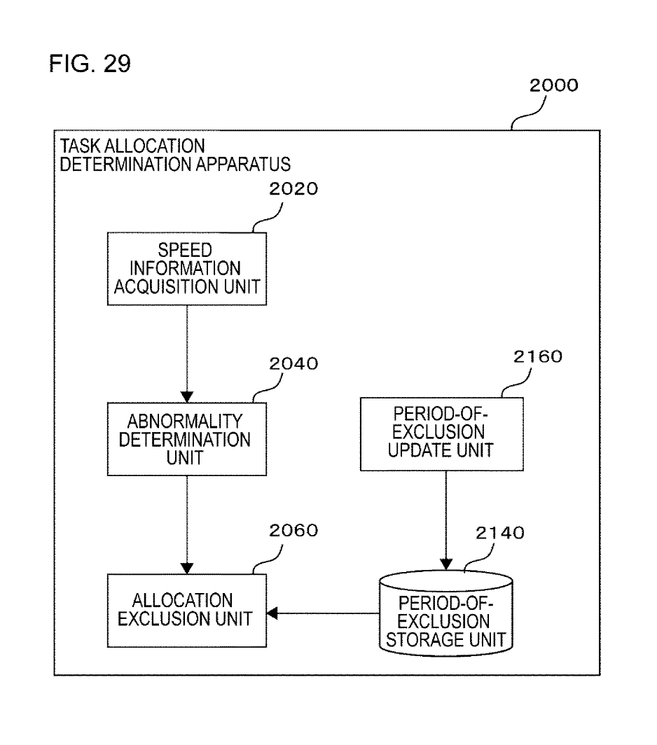

FIG. 29 is a diagram illustrating a configuration of an allocation determination apparatus 2000 according to Exemplary embodiment 6. In FIG. 29, arrows indicate a flow of information. Further, in FIG. 29, each block represents a function-based block rather than a hardware-based configuration. Except for the following description, the allocation determination apparatus 2000 of Exemplary embodiment 6 is the same as the allocation determination apparatus 2000 of Exemplary embodiment 5.

<Period-of-Exclusion Storage Unit 2140>

The period-of-exclusion storage unit 2140 of Exemplary embodiment 6 stores a period of exclusion for each processing server 3200.

<Period-of-Exclusion Update Unit 2160>

When the processing speed of a target task is determined to be abnormal by the abnormality determination unit 2040, a period-of-exclusion update unit 2160 updates a period of exclusion corresponding to the processing server 3200 to which the target task is allocated.

For example, the period-of-exclusion update unit 2160 updates a period of exclusion so that the period of exclusion becomes longer as the number of times of exclusion from the allocation targets of a new task becomes larger. For example, in this case, the period-of-exclusion update unit 2160 updates the period of exclusion using the following Expression (1). Here, i indicates an ID of the processing server 3200. Hereinafter, the processing server 3200 having the ID of i is also denoted by a processing server 3200-i. P(i) indicates a period of exclusion corresponding to the processing server 3200-i. In addition, T(i) is the number of times the processing server 3200-i has been excluded from the allocation targets of a new task. In addition, α is a predetermined constant.

[Expression 1]

P(i)=αT(i) (1)

In this case, the period-of-exclusion storage unit 2140 further stores the number of times of that each processing server 3200 has been excluded from the allocation targets of a new task.

In addition, the number of times of that the processing server 3200 has been temporarily excluded from the allocation targets of a new task, which is used in the above-mentioned method, may be the number of times of that within a predetermined period in the past, and may be the number of times of that within all the past periods.

<Allocation Exclusion Unit 2060>

When the processing speed of a target task is determined to be abnormal by the abnormality determination unit 2040, during a period of exclusion corresponding to the processing server 3200 to which the target task is allocated, the allocation exclusion unit 2060 of Exemplary embodiment 6 excludes this processing server 3200 from the allocation targets of a new task.

<Flow of Processes>

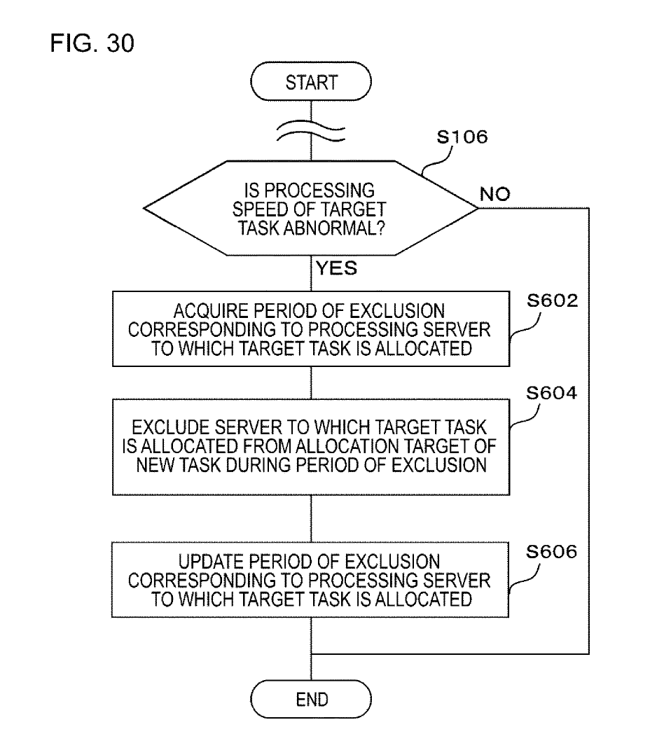

FIG. 30 is a flow diagram illustrating a flow of processes executed by the allocation determination apparatus 2000 of Exemplary embodiment 6. The allocation determination apparatus 2000 of Exemplary embodiment 6 executes the processes of steps S102 and S104 shown in FIG. 4 in the same flow as that in the allocation determination apparatus 2000 of Exemplary embodiment 1 before performing the process of step S106. For the purpose of simplifying the drawing, steps S102 and S104 are omitted in FIG. 30.

In step S602, the period-of-exclusion update unit 2160 acquires a period of exclusion corresponding to the processing server 3200 executing the target task, from the period-of-exclusion storage unit 2140. In step S604, the allocation exclusion unit 2060 excludes the processing server 3200 from the allocation targets of a new task, during the period of exclusion corresponding to the processing server 3200 to which the target task is allocated. In step S606, the period-of-exclusion update unit 2160 updates the acquired period of exclusion.

<Operational Advantages>

According to the present exemplary embodiment, the period of exclusion is set for each processing server 3200. Therefore, it is possible to set an appropriate period of exclusion for each processing server 3200, in accordance with the characteristics of the processing server 3200, the characteristics of a task executed on the processing server 3200, or the like.

In addition, according to allocation determination apparatus 2000 of the present exemplary embodiment, when the processing server 3200 is temporarily excluded from the allocation targets of a new task, a period of exclusion corresponding to the processing server 3200 is updated. Thereby, for example, it is possible to increase a period of exclusion as the number of times of exclusion from the allocation targets of a new task becomes larger. The processing server 3200 having a large number of times of exclusion from the allocation targets of a new task is considered to be a processing server 3200 in which the processing speed of a task tends to be abnormal. Therefore, according to the allocation determination apparatus 2000 of the present exemplary embodiment, it is possible to exclude during a longer period a processing server 3200 in which the processing speed of a task has a greater tendency to be abnormal, from the allocation targets of a new task. Therefore, it is possible to more efficiently prevent the progress of a newly allocated task from being delayed. In addition, since the processing server 3200 in which the processing speed of a task has a greater tendency to be abnormal is not required to be handled as a processing target of the allocation determination apparatus 2000 during a longer period, it is possible to reduce the processing load on the allocation determination apparatus 2000.

### Exemplary Embodiment 7

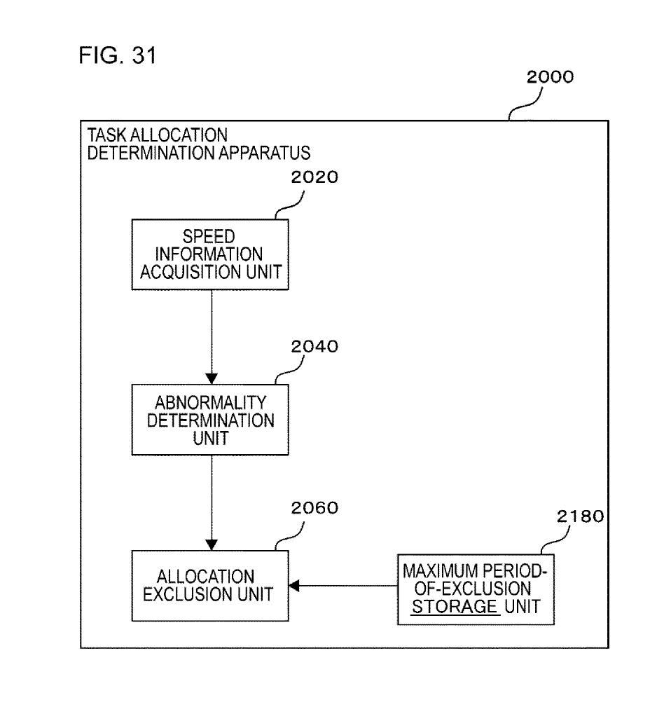

FIG. 31 is a diagram illustrating a configuration of an allocation determination apparatus 2000 according to Exemplary embodiment 7. In FIG. 31, arrows indicate a flow of information. Further, in FIG. 31, each block represents a function-based block rather than a hardware-based configuration. Except for the following description, the allocation determination apparatus 2000 of Exemplary embodiment 7 is the same as the allocation determination apparatus 2000 of Exemplary embodiment 1.

<Maximum Period-of-Exclusion Storage Unit 2180>

The allocation determination apparatus 2000 of Exemplary embodiment 7 includes a maximum period-of-exclusion storage unit 2180. The maximum period-of-exclusion storage unit 2180 stores the maximum value of a period of exclusion.

<Allocation Exclusion Unit 2060>

The allocation exclusion unit 2060 determines whether or not the processing server 3200 executing a target task, the processing speed of which is determined to be abnormal by the abnormality determination unit 2040, has already been temporarily excluded from the allocation targets of a new task. Here, as described above, the processing server 3200 temporarily excluded from the allocation targets of a task is also denoted by an excluded server. When this processing server 3200 is an excluded server, the allocation exclusion unit 2060 determines whether or not the elapsed time from a time point at which this processing server 3200 is set as an excluded server exceeds the maximum value of a period of exclusion, which is stored in the maximum period-of-exclusion storage unit 2180. When the elapsed time from a time point at which this processing server 3200 is set as an excluded server exceeds the maximum value of a period of exclusion stored in the maximum period-of-exclusion storage unit 2180, the maximum period-of-exclusion storage unit 2180 sets this processing server 3200 as an allocation target of a new task.

The allocation exclusion unit 2060 ascertains whether or not the processing server 3200 executing a target task has already been set as an excluded server. For example, the allocation exclusion unit 2060 acquires information indicating whether or not the processing server 3200 executing a target task has already been set as an excluded server, from the inside or outside of the allocation determination apparatus 2000. In this case, for example, a storage unit is installed inside or outside of the allocation determination apparatus 2000, which storage unit stores information indicating whether or not the processing server 3200 is an excluded server for each of processing servers 3200. The allocation exclusion unit 2060 acquires information from this storage unit.

The allocation exclusion unit 2060 ascertains the elapsed time from a time point at which the processing server 3200 is set as an excluded server. For example, the allocation exclusion unit 2060 acquires information indicating a time point at which the processing server 3200 is set as an excluded server, from the inside or outside of the allocation determination apparatus 2000. In this case, for example, a storage unit is installed inside or outside of the allocation determination apparatus 2000, which storage unit stores information indicating a time point at which the processing server 3200 is set as an excluded server, for each of processing servers 3200 set as an excluded server. The allocation exclusion unit 2060 acquires a time point at which the processing server 3200 is set as an excluded server from this storage unit, and calculates the elapsed time from the time point at which the processing server 3200 is set as an excluded server, on the basis of a difference between the current time and this time point. Note that, the elapsed time from the time point at which the processing server 3200 is set as an excluded server can be calculated outside of the allocation determination apparatus 2000. In this case, the allocation exclusion unit 2060 acquires the elapsed time calculated outside.

<Flow of Processes>

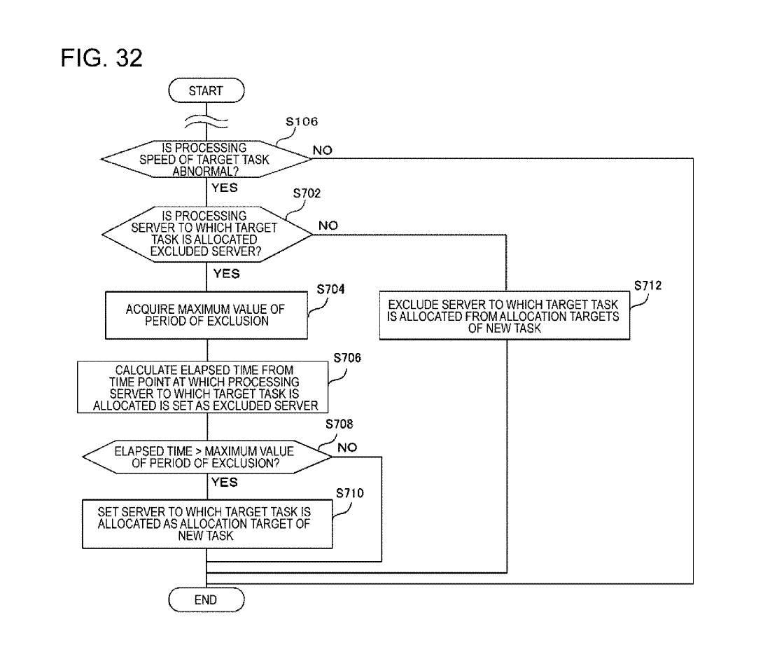

FIG. 32 is a flow diagram illustrating a flow of processes executed by the allocation determination apparatus 2000 of Exemplary embodiment 7. The allocation determination apparatus 2000 of Exemplary embodiment 7 executes the processes of steps S102 and S104 shown in FIG. 4 in the same flow as that in the allocation determination apparatus 2000 of Exemplary embodiment 1 before performing the process of step S106. For the purpose of simplifying the drawing, steps S102 and S104 are omitted in FIG. 32.

In step S702, the allocation exclusion unit 2060 determines whether or not the processing server 3200 executing a target task has already been set as an excluded server. When this processing server 3200 has not yet been set as an excluded server, the process of FIG. 32 proceeds to step S712. On the other hand, when this processing server 3200 has already been set as an excluded server, the process of FIG. 32 proceeds to step S704.

In step S704, the allocation exclusion unit 2060 acquires the maximum value of a period of exclusion from the maximum period-of-exclusion storage unit 2180. In step S706, the allocation exclusion unit 2060 calculates the elapsed time from the time point at which the processing server 3200 is set as an excluded server.

In step S708, the allocation exclusion unit 2060 compares the elapsed time from the time point at which the processing server 3200 is set as an excluded server with the maximum value of a period of exclusion. When the relation of “the elapsed time from the time point at which the processing server 3200 is set as an excluded server>the maximum value of a period of exclusion” is established, the process of FIG. 32 proceeds to step S710. On the other hand, when the relation of “the elapsed time from the time point at which the processing server 3200 is set as an excluded server>the maximum value of a period of exclusion” is not established, the process of FIG. 32 is terminated.

In step S710, the allocation exclusion unit 2060 sets the processing server 3200 as an allocation target of a new task. On the other hand, in step S712, the allocation exclusion unit 2060 temporarily excludes the processing server 3200 from the allocation targets of a new task.

<Operational Advantages>

According to the present exemplary embodiment, a limit can be provided to a period during which the processing server 3200 is excluded from the allocation targets of a new task. Thereby, it is possible to prevent a task from continually not being allocated to the processing server 3200.

### Example 3

Hereinafter, an allocation determination apparatus 2000 according to a combination of Exemplary embodiments 6 and 7 will be described with reference to an example. Note that, the following is an example of a behavior of the allocation determination apparatus 2000. The present exemplary embodiment is not limited to the behavior example shown below at all.

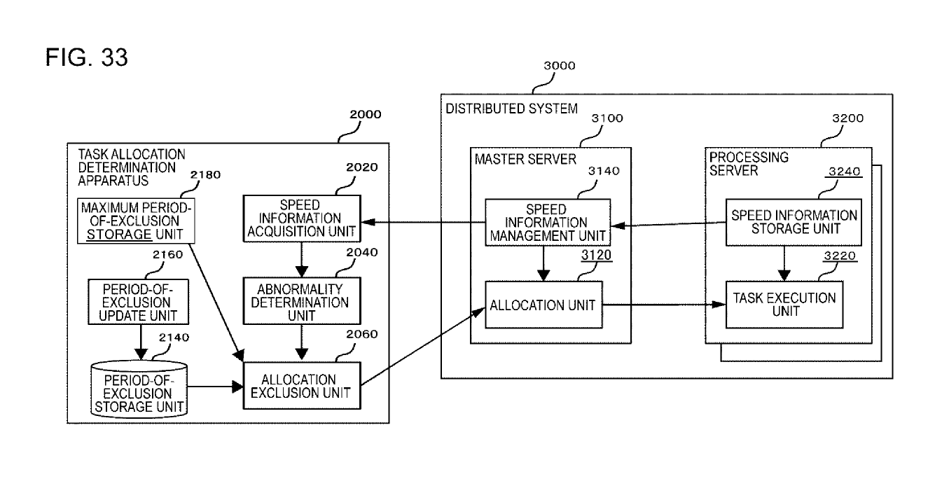

FIG. 33 is a block diagram illustrating an allocation determination apparatus 2000 in Example 3 and its usage environment. Note that, the configuration of a distributed system 3000 in FIG. 33 is the same as the configuration of the distributed system 3000 in Example 1 shown in FIG. 5.

Processing servers 3200 included in the distributed system 3000 in Example 3 are represented in FIG. 6 similarly to Example 1.

A period of exclusion stored by the period-of-exclusion storage unit 2140 in Example 3 indicates the number of times of that the processing server 3200 has been temporarily excluded from the allocation targets of a new task. Here, the period-of-exclusion storage unit 2140 stores a period of exclusion. In addition, the period-of-exclusion updates unit 2160 sets a period of exclusion after update as twice the current cumulative period of exclusion.

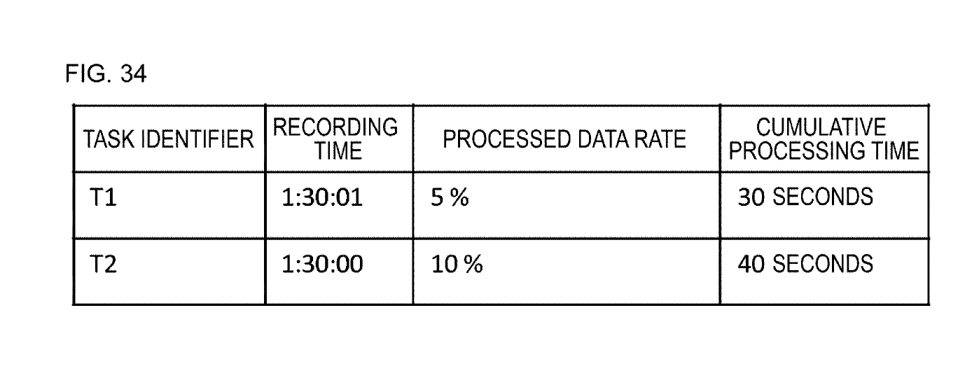

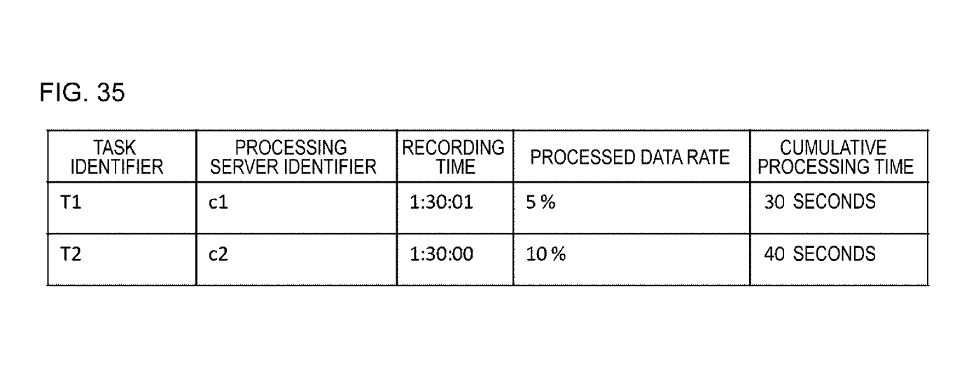

Similarly to Example 1, each computer monitors the state of a task in execution, and stores speed information relating to the task in execution in the speed information storage unit 3240. FIG. 34 is a diagram collectively illustrating speed information stored in the speed information storage units 3240 of the computers c1 and c2. In the present example, the speed information indicates two indices relating to the processing speed of a task. The first index is a ratio of the amount of processed data to the amount of data to be processed. Hereinafter, this ratio is denoted by a processed data rate. The second index is a cumulative processing time. For example, a record 1 of FIG. 34 indicates that the processed data rate of the task T1 is 5% at time 1:30:01, and that the cumulative processing time of the task T1 is 30 seconds. In addition, FIG. 35 illustrates speed information managed by the speed information management unit 3140.

Here, the master server 3100 is configured to allocate a new task T3 to the processing server 3200. Since a task is not allocated to a task execution unit P2 of the computer c1, the master server 3100 attempts to allocate the task T3 to the computer c1. During the process, the allocation unit 3120 provides the allocation determination apparatus 2000 with the computer c1 as an input. The allocation determination apparatus 2000 determines whether or not the computer c1 is temporarily excluded from the allocation targets of a new task.

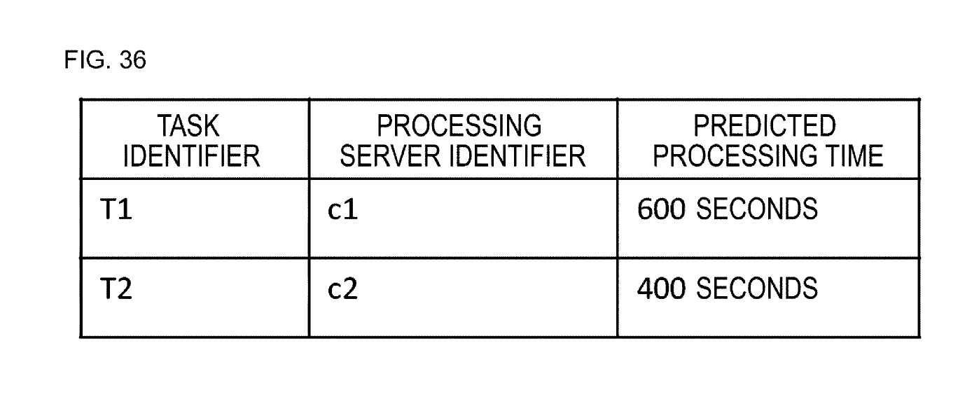

In Example 3, the abnormality determination unit 2040 uses a predicted processing time t′ calculated using a processed data rate r and a cumulative processing time t, as an index value indicating the processing speed of a task. As a specific calculation expression, the relation of t′=t/r is used. FIG. 36 is a diagram illustrating the processing speed of a task calculated by the abnormality determination unit 2040. This figure indicates that the predicted processing time of the task T1 allocated to the computer c1 is 600 seconds, and the predicted processing time of the task T2 allocated to the computer c2 is 400 seconds.

Since the predicted processing time of the task T1 allocated to the computer c1 is longest, the abnormality determination unit 2040 determines the processing speed of the task T1 to be lowest. Thus, the allocation exclusion unit 2060 temporarily excludes the computer c1 from the allocation targets of a new task. As a result, the allocation unit 3120 does not allocate the task T3 to the computer c1.

The period-of-exclusion update unit 2160 updates the cumulative number of times of delay for the computer c1 to 1 on the basis of the above determination result, and stores the result in the period-of-exclusion storage unit 2140. Here, suppose that the allocation unit 3120 of the master server 3100 attempts to allocate the task T3 to the computer c1 again. In this case, the abnormality determination unit 2040 determines the processing speed of the task T1 to be abnormal again. However, the maximum period of exclusion stored in the maximum period-of-exclusion storage unit 2180 is 1, and the computer c1 has already been temporarily excluded once from the allocation targets of a new task. Thus, the allocation exclusion unit 2060 sets the computer c1 as an allocation target of a new task.

However, the abnormality determination unit 2040 determines the processing speed of the task T1 to be abnormal, and thus the period-of-exclusion update unit 2160 updates the maximum period of exclusion stored in the maximum period-of-exclusion storage unit 2180 to 2.

As described above, although the exemplary embodiments of the present invention have been set forth with reference to the accompanying drawings, these exemplary embodiments are merely illustrative of the present invention, and a combination of the above exemplary embodiments and various configurations other than those in the above-mentioned exemplary embodiments can also be adopted.

Hereinafter, examples of reference forms are appended.

1. A task allocation determination apparatus that determines an allocation of a task to each of a plurality of servers constituting a distributed system, the apparatus comprising:

a speed information acquisition unit acquiring speed information, which is information relating to a processing speed of the task in execution on the server;

an abnormality determination unit determining whether or not a processing speed of a task to be determined is abnormal, using the speed information; and

an allocation exclusion unit temporarily excluding the server from allocation targets of a new task, the server having been allocated the task to be determined the processing speed of which is determined to be abnormal by the abnormality determination unit.

2. The task allocation determination apparatus according to 1, further comprising a speed history acquisition unit acquiring a speed history, which is a history of the processing speed of the task,

wherein the abnormality determination unit determines whether or not the processing speed of the task to be determined is abnormal by comparing the processing speed of the task to be determined with the speed history of the task to be determined.

3. The task allocation determination apparatus according to 2, further comprising a normal range calculation unit calculating a normal speed range, which is a range of a normal processing speed of the task to be determined, on the basis of the speed history of the task to be determined,

wherein the abnormality determination unit determines that the processing speed of the task to be determined is abnormal when the processing speed of the task to be determined is not included in the normal speed range.

4. The task allocation determination apparatus according to 1, wherein the abnormality determination unit determines whether or not the processing speed of the task to be determined is abnormal by comparing the processing speed of the task to be determined with the processing speed of the task other than the task to be determined.

5. The task allocation determination apparatus according to 4, further comprising a normal range calculation unit calculating a normal speed range, which is a range of a normal processing speed of the task to be determined, on the basis of processing speeds of tasks other than the task to be determined, or processing speeds of a plurality of the tasks including the task to be determined,

wherein the abnormality determination unit determines that the processing speed of the task to be determined is abnormal when the processing speed of the task to be determined is not included in the normal speed range.

6. The task allocation determination apparatus according to 4 or 5, further comprising a task class acquisition unit acquiring a task class corresponding to the task,

wherein the task of a target for the abnormality determination unit to compare with the task to be determined corresponds to the same task class as that of the task to be determined.

7. The task allocation determination apparatus according to any one of 1 to 6, further comprising a period-of-exclusion storage unit storing a period of exclusion, which is a period during which the server is excluded from the allocation targets of a new task,

wherein when the processing speed of the task to be determined is determined to be abnormal by the abnormality determination unit, the allocation exclusion unit excludes the server to which the task to be determined is allocated, during the period of exclusion, from the allocation targets of a new task.

8. The task allocation determination apparatus according to 7, wherein the period-of-exclusion storage unit stores the period of exclusion for each of the servers, and

wherein when the processing speed of the task to be determined is determined to be abnormal by the abnormality determination unit, the allocation exclusion unit excludes the server to which the task to be determined is allocated, during the period of exclusion associated with the server, from the allocation targets of a new task, and

wherein the apparatus comprises a period-of-exclusion update unit updating the period of exclusion associated with the server to which the task to be determined is allocated, when the processing speed of the task to be determined is determined to be abnormal by the abnormality determination unit.

9. The task allocation determination apparatus according to any one of 1 to 8, further comprising a maximum period-of-exclusion storage unit storing a maximum value of a period of exclusion during which the processing server is excluded from the allocation targets of a new task,

wherein when the server executing the task to be determined, the processing speed of which is determined to be abnormal by the abnormality determination unit, has already been excluded from the allocation targets of a new task, and when an elapsed time from a time point at which the server has been excluded from the allocation targets of a new task exceeds the maximum value of the period of exclusion, the allocation exclusion unit sets the server as the allocation target of a new task.

10. A control method executed by a computer that determines an allocation of a task to each of a plurality of servers constituting a distributed system, the method comprising:

a speed information acquisition step of acquiring speed information, which is information relating to a processing speed of the task in execution on the server;

an abnormality determination step of determining whether or not a processing speed of a task to be determined is abnormal using the speed information; and

an allocation exclusion step of temporarily excluding the server from allocation targets of a new task, the server having been allocated the task to be determined the processing speed of which is determined to be abnormal by the abnormality determination step.

11. The control method according to 10, further including a speed history acquisition step of acquiring a speed history, which is a history of the processing speed of the task,

wherein in the abnormality determination step, it is determined whether or not the processing speed of the task to be determined is abnormal by comparing the processing speed of the task to be determined with the speed history of the task to be determined.

12. The control method according to 11, further including a normal range calculation step of calculating a normal speed range, which is a range of a normal processing speed of the task to be determined, on the basis of the speed history of the task to be determined,

wherein in the abnormality determination step, it is determined that the processing speed of the task to be determined is abnormal when the processing speed of the task to be determined is not included in the normal speed range.

13. The control method according to 10, wherein in the abnormality determination step, it is determined whether or not the processing speed of the task to be determined is abnormal by comparing the processing speed of the task to be determined with the processing speed of the task other than the task to be determined.

14. The control method according to 13, further including a normal range calculation step of calculating a normal speed range, which is a range of a normal processing speed of the task to be determined, on the basis of processing speeds of tasks other than the task to be determined, or processing speeds of a plurality of the tasks including the task to be determined,

wherein in the abnormality determination step, it is determined that the processing speed of the task to be determined is abnormal when the processing speed of the task to be determined is not included in the normal speed range.

15. The control method according to 13 or 14, further including a task class acquisition step of acquiring a task class corresponding to the task,

wherein the task of a target for the abnormality determination step to compare with the task to be determined corresponds to the same task class as that of the task to be determined.

16. The control method according to any one of 10 to 15, wherein the computer includes a period-of-exclusion storage unit storing a period of exclusion, which is a period during which the server is excluded from the allocation targets of a new task, and

wherein in the allocation exclusion step, when the processing speed of the task to be determined is determined to be abnormal by the abnormality determination step, the server to which the task to be determined is allocated is excluded from the allocation targets of a new task during the period of exclusion.

17. The control method according to 16, wherein the period-of-exclusion storage unit stores the period of exclusion for each of the servers, and

wherein in the allocation exclusion step, when the processing speed of the task to be determined is determined to be abnormal by the abnormality determination step, the server to which the task to be determined is allocated is excluded, during the period of exclusion associated with the server, from the allocation target of a new task, and

wherein the method including a period-of-exclusion update step updating the period of exclusion associated with the server to which the task to be determined is allocated, when the processing speed of the task to be determined is determined to be abnormal by the abnormality determination step.

18. The control method according to any one of 10 to 17, wherein the computer includes a maximum period-of-exclusion storage unit storing a maximum value of a period of exclusion during which the processing server is excluded from the allocation targets of a new task, and

wherein when the server executing the task to be determined, the processing speed of which is determined to be abnormal by the abnormality determination unit, has already been excluded from the allocation targets of a new task, and when an elapsed time from a time point at which the server has been excluded from the allocation targets of a new task exceeds the maximum value of the period of exclusion, in the allocation exclusion step, the server is set as the allocation target of a new task.

19. A program causing a computer to have a function of operating as a task allocation determination apparatus that determines an allocation of a task to each of a plurality of servers constituting a distributed system, the program causing the computer to have:

a speed information acquisition function of acquiring speed information, which is information relating to a processing speed of the task in execution on the server;

an abnormality determination function of determining whether or not a processing speed of a task to be determined is abnormal, using the speed information; and

an allocation exclusion function of temporarily excluding the server from allocation targets of a new task, the server having been allocated the task to be determined the processing speed of which is determined to be abnormal by the abnormality determination function.

20. The program according to 19, further including a speed history acquisition function of acquiring a speed history, which is a history of the processing speed of the task,

wherein in the abnormality determination function, it is determined whether or not the processing speed of the task to be determined is abnormal by comparing the processing speed of the task to be determined with the speed history of the task to be determined.

21. The program according to 20, further including a normal range calculation function of calculating a normal speed range which is a range of a normal processing speed of the task to be determined, on the basis of the speed history of the task to be determined,

wherein in the abnormality determination function, it is determined that the processing speed of the task to be determined is abnormal when the processing speed of the task to be determined is not included in the normal speed range.

22. The program according to 19, wherein in the abnormality determination function, it is determined whether the processing speed of the task to be determined is abnormal by comparing the processing speed of the task to be determined with the processing speed of the task other than the task to be determined.

23. The program according to 22, further including a normal range calculation function of calculating a normal speed range which is a range of a normal processing speed of the task to be determined, on the basis of processing speeds of tasks other than the task to be determined, or processing speeds of a plurality of the tasks including the task to be determined,

wherein in the abnormality determination function, it is determined that the processing speed of the task to be determined is abnormal when the processing speed of the task to be determined is not included in the normal speed range.

24. The program according to 22 or 23, further including a task class acquisition function of acquiring a task class corresponding to the task,

wherein the task of a target for the abnormality determination function to compare with the task to be determined corresponds to the same task class as that of the task to be determined.

25. The control method according to any one of 19 to 24, wherein the computer includes a period-of-exclusion storage unit storing a period of exclusion, which is a period during which the server is excluded from the allocation targets of a new task, and

wherein in the allocation exclusion function, when the processing speed of the task to be determined is determined to be abnormal by the abnormality determination function, the server to which the task to be determined is allocated is excluded from the allocation target of a new task during the period of exclusion.

26. The program according to 25, wherein the period-of-exclusion storage unit stores the period of exclusion for each of the servers, and

wherein in the allocation exclusion function, when the processing speed of the task to be determined is determined to be abnormal by the abnormality determination function, the server to which the task to be determined is allocated is excluded, during the period of exclusion associated with the server, from the allocation target of a new task, and

wherein the program further includes a period-of-exclusion update function updating the period of exclusion associated with the server to which the task to be determined is allocated, when the processing speed of the task to be determined is determined to be abnormal by the abnormality determination function.

27. The program according to any one of 19 to 26, wherein the computer includes a maximum period-of-exclusion storage unit storing a maximum value of a period of exclusion during which the processing server is excluded from the allocation targets of a new task, and

wherein when the server executing the task to be determined, the processing speed of which is determined to be abnormal by the abnormality determination unit, has already been excluded from the allocation targets of a new task, and when an elapsed time from a time point at which the server has been excluded from the allocation targets of a new task exceeds the maximum value of the period of exclusion, in the allocation exclusion function, the server is set as the allocation target of a new task.

The application claims priority from Japanese Application No. 2013-139860 filed on Jul. 3, 2013, the content of which is incorporated herein by reference in its entirety.

1. A task allocation determination apparatus that determines an allocation of a task to each of a plurality of servers constituting a distributed system, the apparatus comprising:
a speed information acquisition unit acquiring speed information, which is information relating to a processing speed of the task in execution on the server;
an abnormality determination unit determining whether or not a processing speed of a task to be determined is abnormal, using the speed information; and
an allocation exclusion unit temporarily excluding the server from allocation targets of a new task, the server having been allocated the task to be determined the processing speed of which is determined to be abnormal by the abnormality determination unit.

2. The task allocation determination apparatus according to claim 1, further comprising a speed history acquisition unit acquiring a speed history, which is a history of the processing speed of the task,
wherein the abnormality determination unit determines whether or not the processing speed of the task to be determined is abnormal by comparing the processing speed of the task to be determined with the speed history of the task to be determined.

3. The task allocation determination apparatus according to claim 2, further comprising a normal range calculation unit calculating a normal speed range, which is a range of a normal processing speed of the task to be determined, on the basis of the speed history of the task to be determined,
wherein the abnormality determination unit determines that the processing speed of the task to be determined is abnormal when the processing speed of the task to be determined is not included in the normal speed range.

4. The task allocation determination apparatus according to claim 1, wherein the abnormality determination unit determines whether or not the processing speed of the task to be determined is abnormal by comparing the processing speed of the task to be determined with the processing speed of the task other than the task to be determined.

5. The task allocation determination apparatus according to claim 4, further comprising a normal range calculation unit calculating a normal speed range, which is a range of a normal processing speed of the task to be determined, on the basis of processing speeds of tasks other than the task to be determined, or processing speeds of a plurality of the tasks including the task to be determined,
wherein the abnormality determination unit determines that the processing speed of the task to be determined is abnormal when the processing speed of the task to be determined is not included in the normal speed range.

6. The task allocation determination apparatus according to claim 4, further comprising a task class acquisition unit acquiring a task class corresponding to the task,
wherein the task of a target for the abnormality determination unit to compare with the task to be determined corresponds to the same task class as that of the task to be determined.

7. The task allocation determination apparatus according to claim 1, further comprising a period-of-exclusion storage unit storing a period of exclusion, which is a period during which the server is excluded from the allocation targets of a new task,
wherein when the processing speed of the task to be determined is determined to be abnormal by the abnormality determination unit, the allocation exclusion unit excludes the server to which the task to be determined is allocated, during the period of exclusion, from the allocation targets of a new task.

8. The task allocation determination apparatus according to claim 7, wherein the period-of-exclusion storage unit stores the period of exclusion for each of the servers, and
wherein when the processing speed of the task to be determined is determined to be abnormal by the abnormality determination unit, the allocation exclusion unit excludes the server to which the task to be determined is allocated, during the period of exclusion associated with the server, from the allocation targets of a new task, and
wherein the apparatus comprises a period-of-exclusion update unit updating the period of exclusion associated with the server to which the task to be determined is allocated, when the processing speed of the task to be determined is determined to be abnormal by the abnormality determination unit.

9. The task allocation determination apparatus according to claim 1, further comprising a maximum period-of-exclusion storage unit storing a maximum value of a period of exclusion during which the processing server is excluded from the allocation targets of a new task,
wherein when the server executing the task to be determined, the processing speed of which is determined to be abnormal by the abnormality determination unit, has already been excluded from the allocation targets of a new task, and when an elapsed time from a time point at which the server has been excluded from the allocation targets of a new task exceeds the maximum value of the period of exclusion, the allocation exclusion unit sets the server as the allocation target of a new task.

10. A control method executed by a computer that determines an allocation of a task to each of a plurality of servers constituting a distributed system, the method comprising executing:
acquiring speed information, which is information relating to a processing speed of the task in execution on the server;
determining whether or not a processing speed of a task to be determined is abnormal using the speed information; and
temporarily excluding the server from allocation targets of a new task, the server having been allocated the task to be determined the processing speed of which is determined to be abnormal by the step of the determination.

11. A non-transitory computer-readable storage medium storing a program causing a computer to have a function of operating as a task allocation determination apparatus that determines an allocation of a task to each of a plurality of servers constituting a distributed system, the program causing the computer to execute:
acquiring speed information, which is information relating to a processing speed of the task in execution on the server;
determining whether or not a processing speed of a task to be determined is abnormal, using the speed information; and
temporarily excluding the server from allocation targets of a new task, the server having been allocated the task to be determined the processing speed of which is determined to be abnormal by the step of the determination.
